(19) United States
(12) Patent Application Publication
(10) Pub. No.: US 2017/0313461 A1
(43) Pub. Date: Nov. 2, 2017

(54) DEVICE AND METHOD FOR JOINING WEBS WITH SELF-ADHESIVE LABELS TO BE SUPPLIED TO A LABELLING MACHINE

(71) Applicant: KOSME S.R.L. UNIPERSONALE, 46048 ROVERBELLA (MANTOVA) (IT)

(72) Inventors: GIOVANNI SACCARDI, MALAVICINA DI ROVERBELLA (IT); ROBERTO BUSI, VIRGILIO (IT); ALESSANDRO CAPRARA, ISOLA DELLA SCALA (IT)

(21) Appl. No.: 15/522,895

(22) PCT Filed: Nov. 10, 2014
(86) PCT No.: PCT/IB2014/065925

§ 371 Date: Apr. 28, 2017

(51) Int. Cl. B65C 9/18; B65H 19/18

(52) U.S. Cl. CPC B65C 9/1807; B65H 19/1863; B65H 19/1836; B65H 2301/464145; B65H 2301/4621; B65H 2301/46152; B65H 2404/1344; B65H 2701/194; B65H 2301/4631

(57) ABSTRACT

A device for joining webs with self-adhesive labels comprises a web retaining element (18) for, in use, selectively retaining the starting end (16) of a new web (13) at an operating zone (15) positioned along a feed path of a first web being used and a pressure element (26) positioned on the opposite side of the first web; at least one of either the retaining element (18) or the pressure element (26) being movable relative to the other, between a non-operating position in which they are at a distance from each other and an operating position in which the pressure element (26) presses the first web (10) onto an adhesive element fixed to the new web (13); it also comprises a cutting (27) movable between a non-interference position and a cutting position, movement means for moving the cutting element (27) from the non-interference position to the cutting position, and controlled feeding means for the first web (10) which are operatively associated with the movement means for causing controlled feeding of the first web (10) in the operating zone (15) during movement of the cutting element (27) towards the cutting position. A method for joining implemented by the device is also claimed.

This invention relates to a device and a method for joining webs with self-adhesive labels to be supplied to a labelling machine.

It is known that labelling machines intended to apply self-adhesive labels (or the related labelling units) are supplied with said labels applied one after another on suitable backing webs which are wound in reels.

Although there are many labels (several thousand) on each reel, the ever increasing productivity of labelling machines has increasingly highlighted the problem linked to the switch from one reel to another, since a reel can be used up within a few dozen minutes.

Where stopping the machine briefly to fit a new reel in the past did not cause particular problems, nowadays that would no longer be possible without drastically reducing productivity.

Consequently, various solutions have gradually been studied and put forward to allow joining of the end of one reel with the start of the next reel without having to stop the machine or which minimise the down time.

In particular, manual solutions were studied (in which joining is performed manually by the operator), as well as semi-automatic solutions and automatic solutions.

In all cases, the machine usually comprises two supports, one for the reel being unwound and one for the new reel, as well as systems for retaining the starting edge of the new reel which already has an adhesive element on it, in a standby position.

However, in all of the prior art machines, the joining operations require slowing of web feed, which has led to the installation between the joining zone and the labelling zone of web storage units constituted of a plurality of return rollers movable in such a way as to lengthen and shorten the web path.

Although the use of a storage unit may substantially solve the productivity issue, to do this effectively the storage unit has to be very large, which means a considerable increase in the machine overall dimensions.

Furthermore, it should be remembered that due to the asymmetrical nature of the webs to be joined (the labels are only present on one side), depending how the two reels and the related webs are positioned, joining may require different operations, making automatic joining operations even more complicated.

In this context, the technical purpose which forms the basis of this invention is to provide a device and a method for joining webs with self-adhesive labels to be supplied to a labelling machine which are alternatives to the prior art solutions.

In particular, the technical purpose of this invention is to provide a device and a method for joining webs with self-adhesive labels to be supplied to a labelling machine which allow joining to be carried out precisely and automatically.

It is also the technical purpose of this invention to provide a device and a method for joining webs with self-adhesive labels to be supplied to a labelling machine which do not require the use of any storage unit for the web downstream of the joining zone, and which at the same time allow slowing of machine operation to be avoided.

It is also the technical purpose of this invention is to provide a device and a method for joining webs with self-adhesive labels to be supplied to a labelling machine which are not affected by the asymmetrical nature of the webs.

The technical purpose specified and the aims indicated are substantially achieved by a device and a method for joining webs with self-adhesive labels to be supplied to a labelling machine as described in the appended claims.

Further features and the advantages of this invention are more apparent in the detailed description, with reference to the accompanying drawings which illustrate several preferred, non-limiting embodiments of a device and a method for joining webs with self-adhesive labels to be supplied to a labelling machine, in which:

FIG. 1 is an axonometric view of a labelling unit of a labelling machine, equipped with a joining device in accordance with this invention;

FIG. 2 shows only the joining device of FIG. 1;

FIG. 3 shows a joining unit of the joining device of FIG. 2, in a first operating configuration; with some parts cut away to better illustrate others;

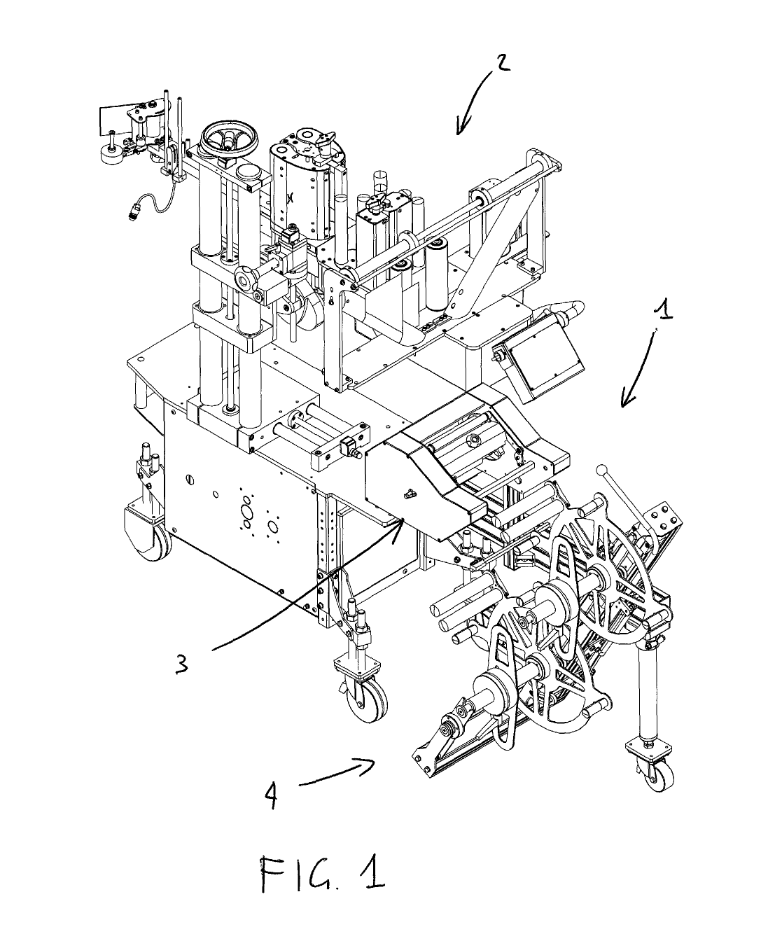

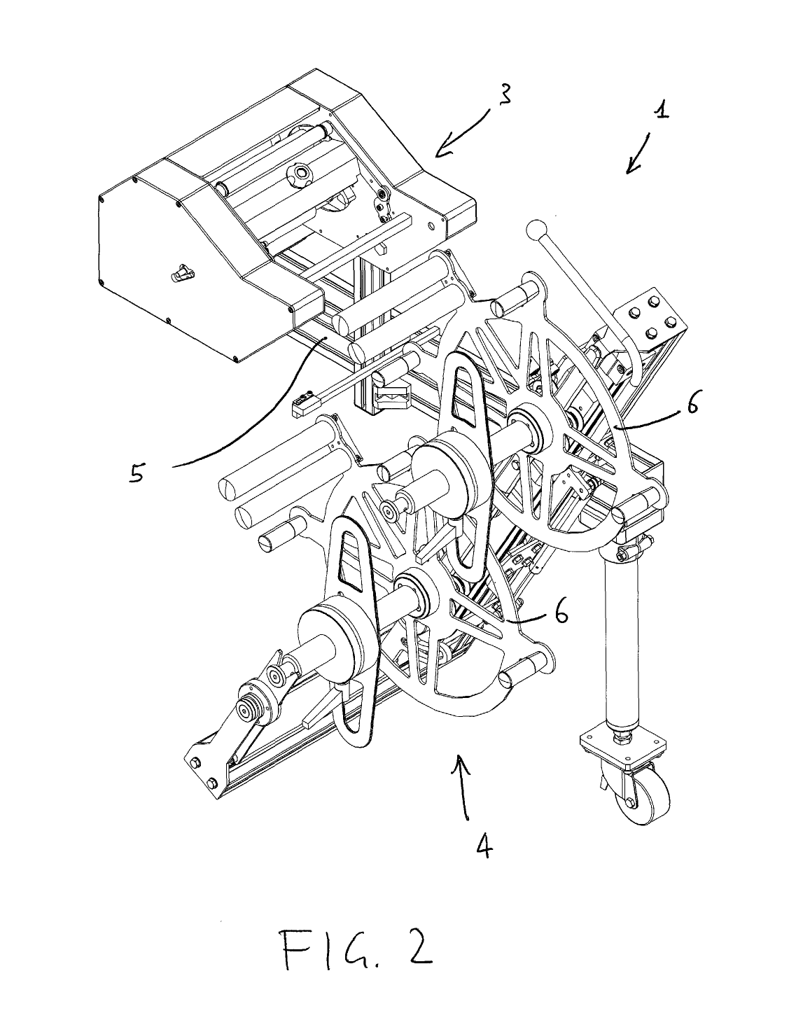

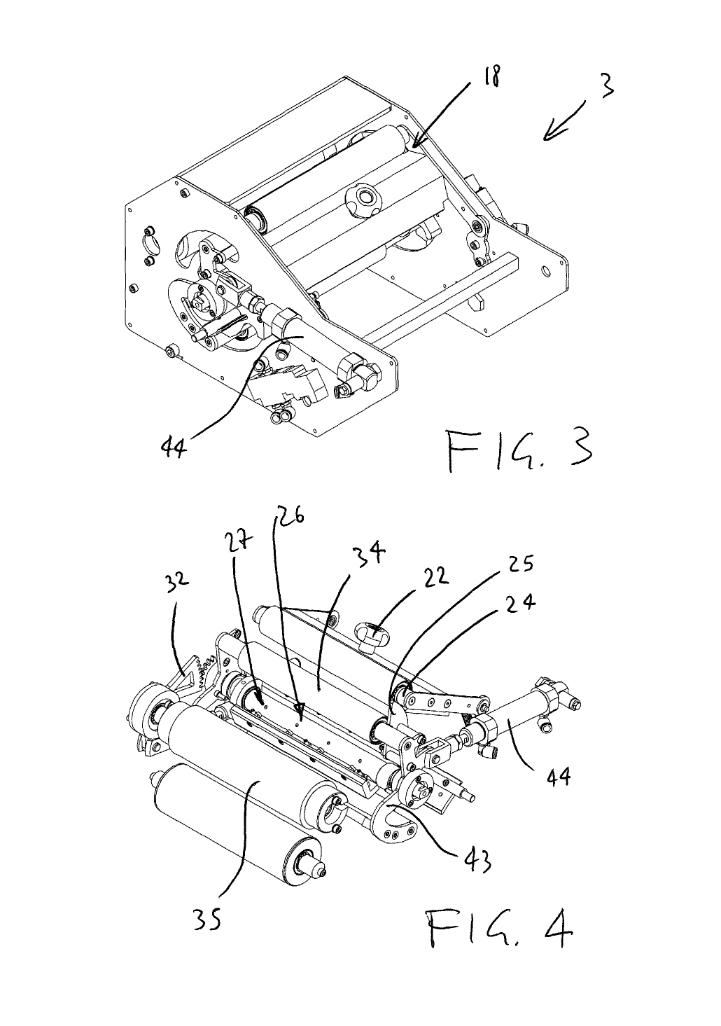

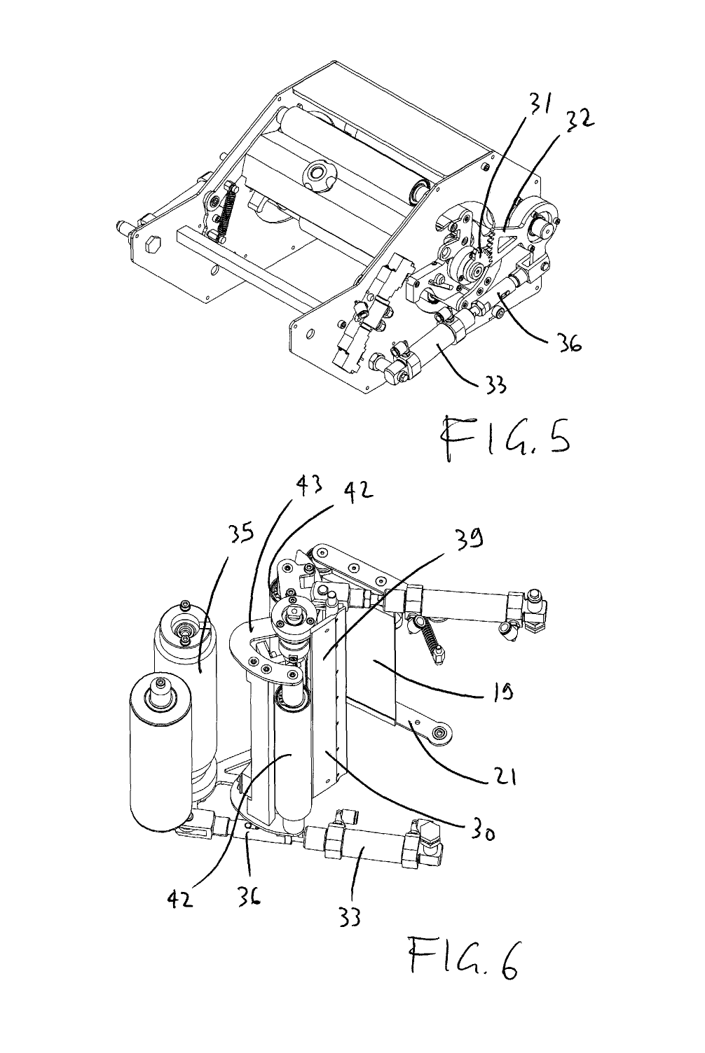

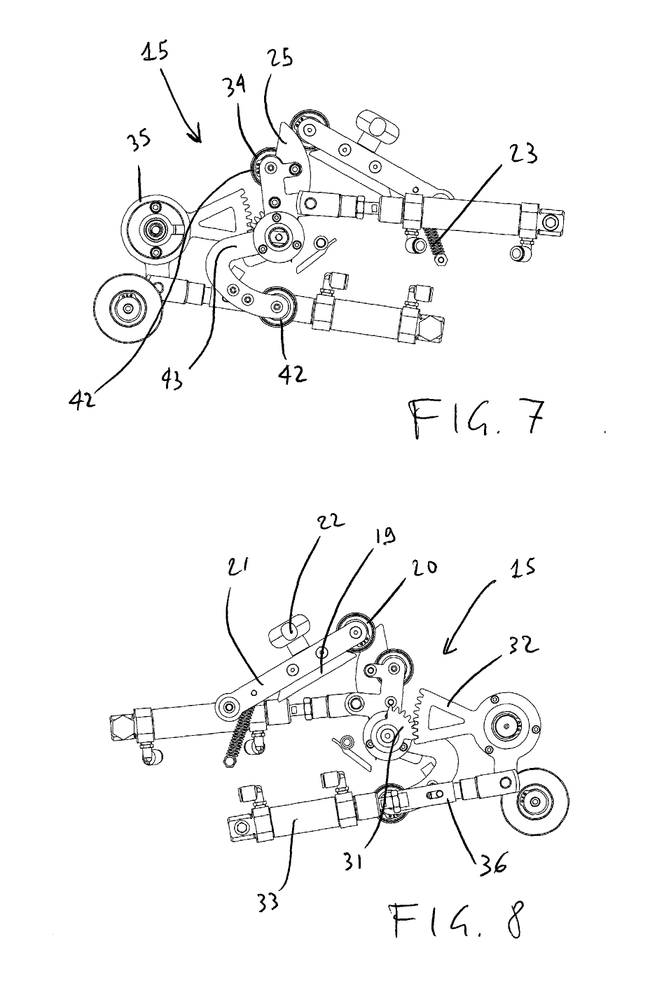

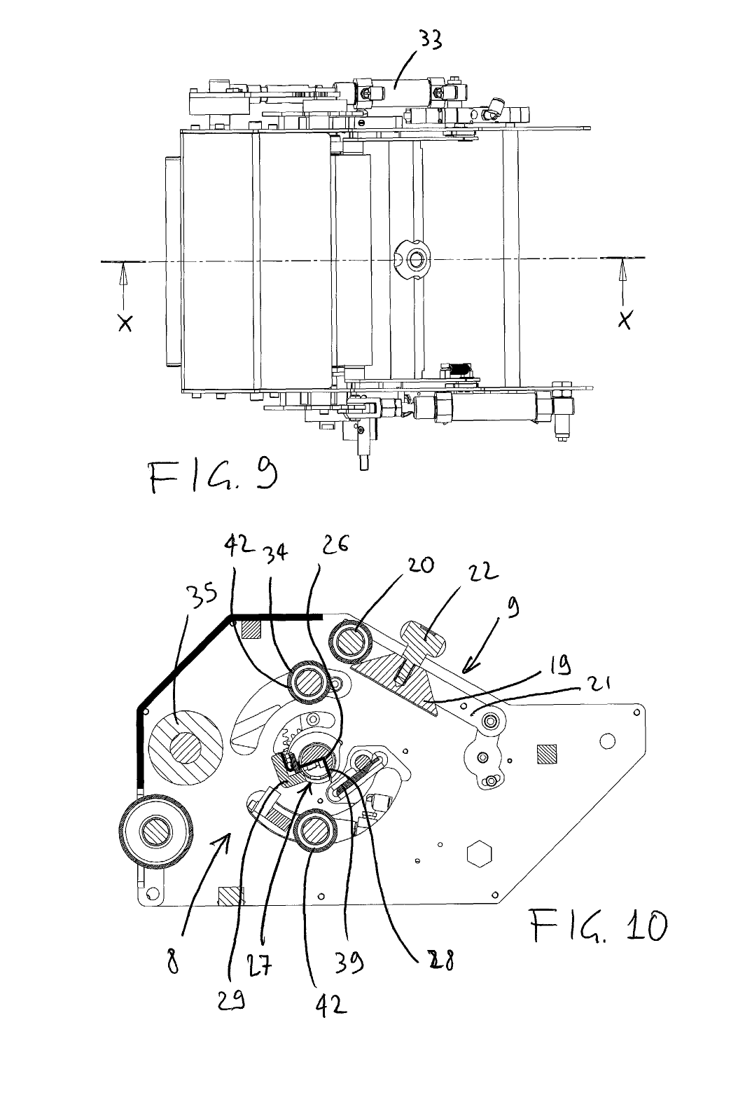

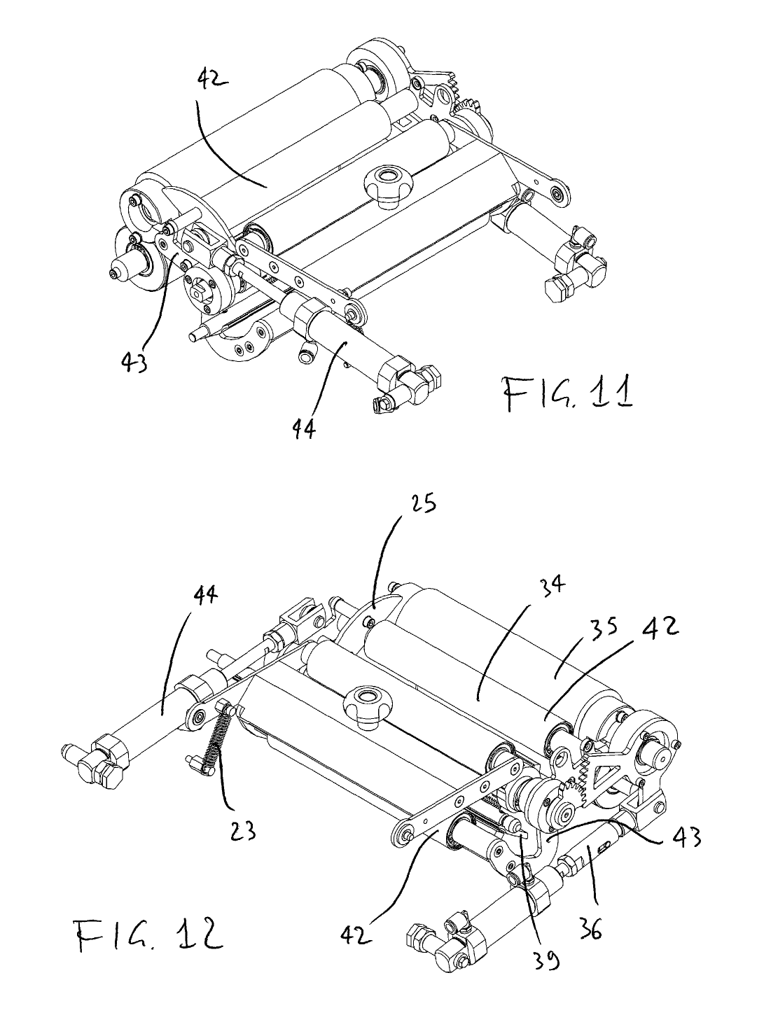

FIG. 4 shows the joining unit of FIG. 3 seen from the left, with further parts cut away to illustrate internal parts;

FIG. 5 shows the other side of the joining unit of FIG. 3;

FIG. 6 is a bottom view of the joining unit of FIG. 4;

FIG. 7 is a side view of the joining unit of FIG. 4 seen from the left;

FIG. 8 is a side view of the joining unit of FIG. 4 seen from the right;

FIG. 9 is a top view of the joining unit of FIG. 3;

FIG. 10 is a cross-section of the joining unit of FIG. 9 according to the line X-X;

FIGS. 11 to 14 show the joining unit of FIGS. 3 to 10 in a second operating configuration;

FIGS. 15 to 18 show the joining unit of FIGS. 3 to 10 in a third operating configuration;

FIGS. 19 and 20 show the joining unit of FIGS. 3 to 10 in a fourth operating configuration;

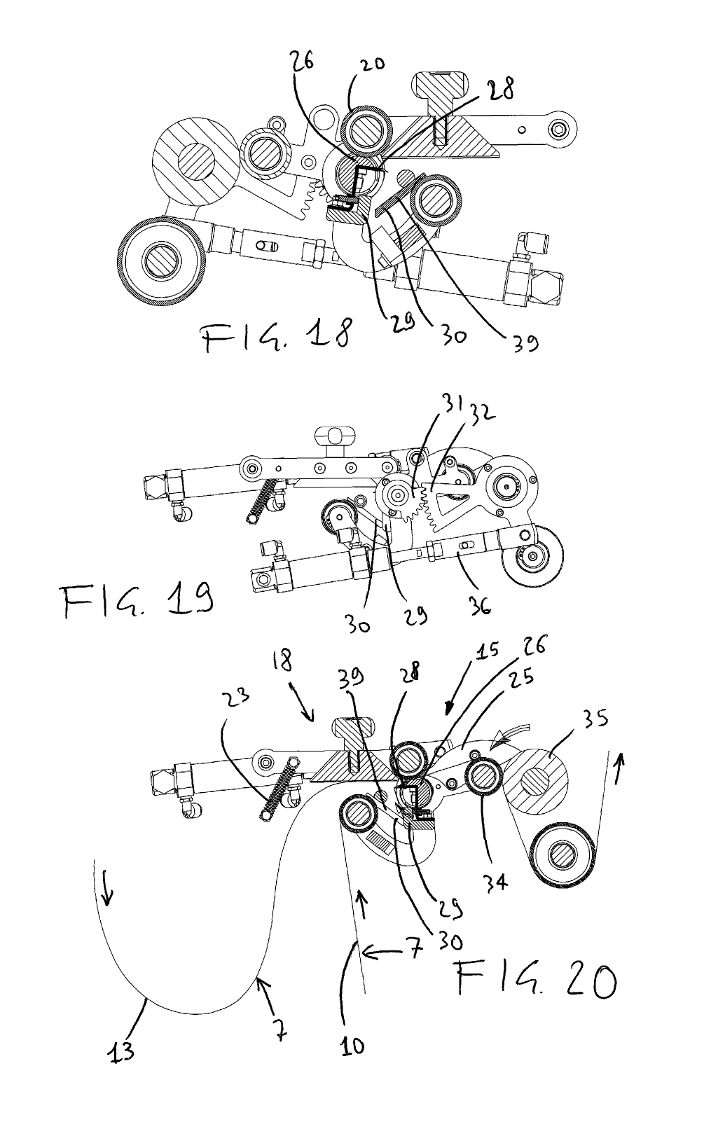

FIG. 21 is an axonometric view of a rocker arm of the joining unit of FIGS. 3 to 20;

FIG. 22 is an axonometric view of a cutting element of the joining unit of FIGS. 3 to 20;

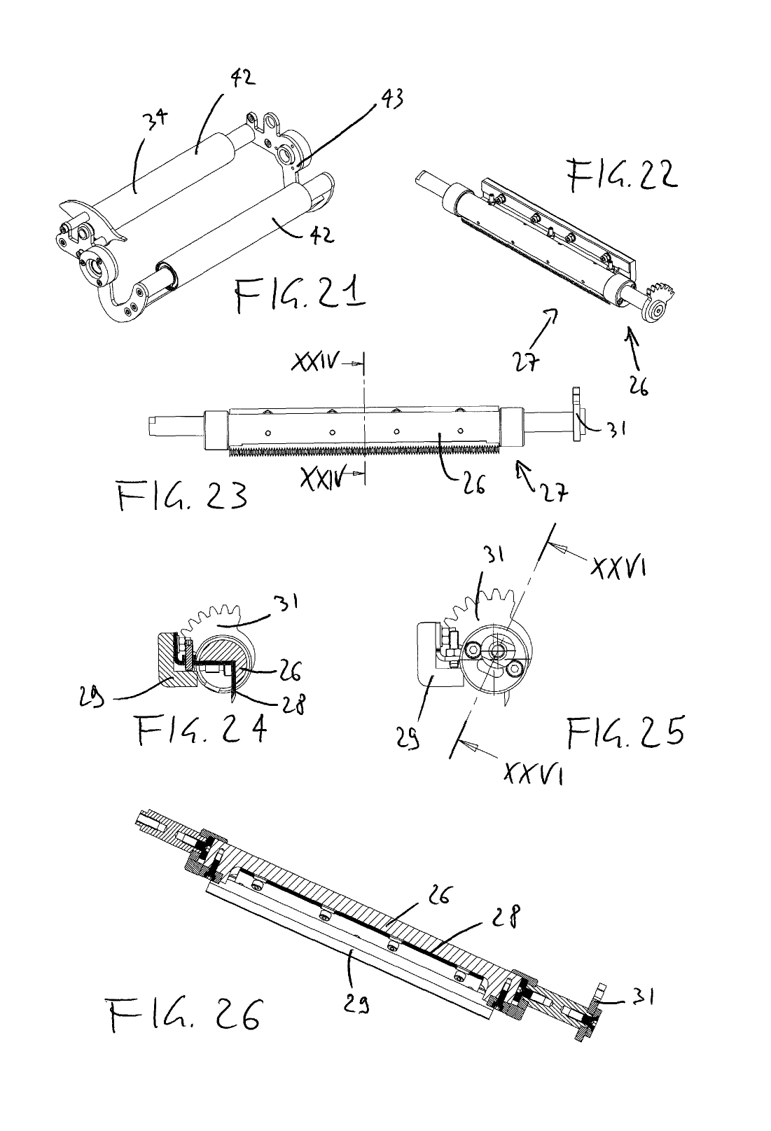

FIG. 23 is a front view of the cutting element of FIG. 22;

FIG. 24 is a cross-section of the cutting element of FIG. 23 according to the line XXIV-XXIV;

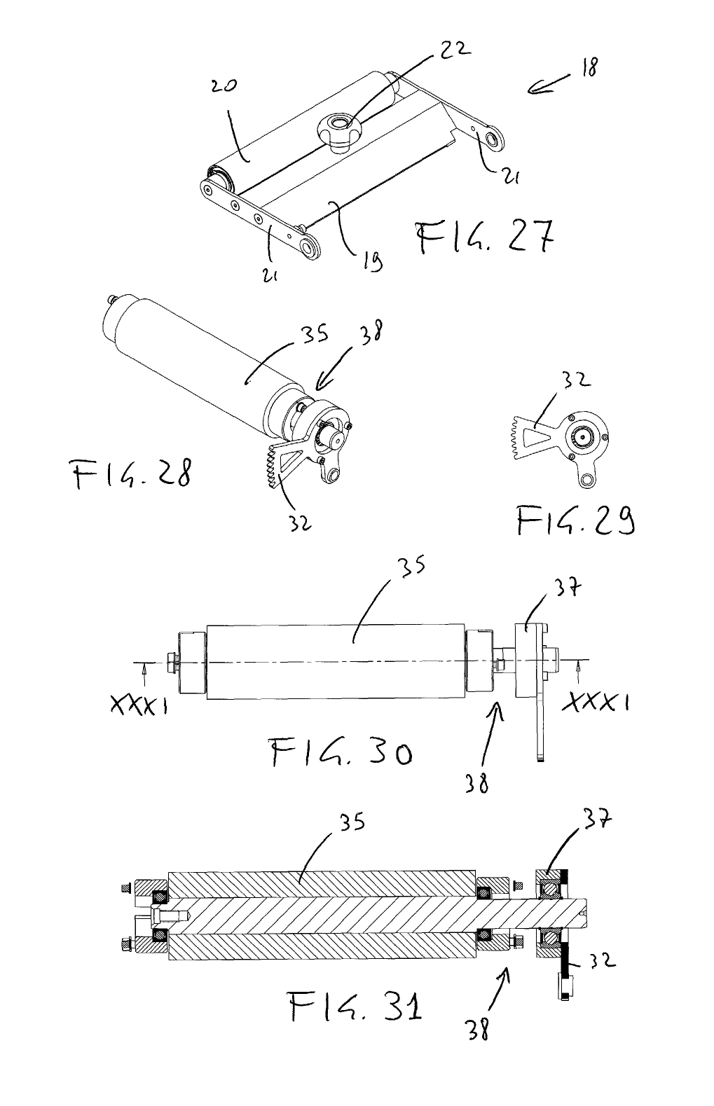

FIG. 25 is a side view of the cutting element of FIG. 23 seen from the left;

FIG. 26 is a cross-section of the cutting element of FIG. 25 according to the line XXVI-XXVI;

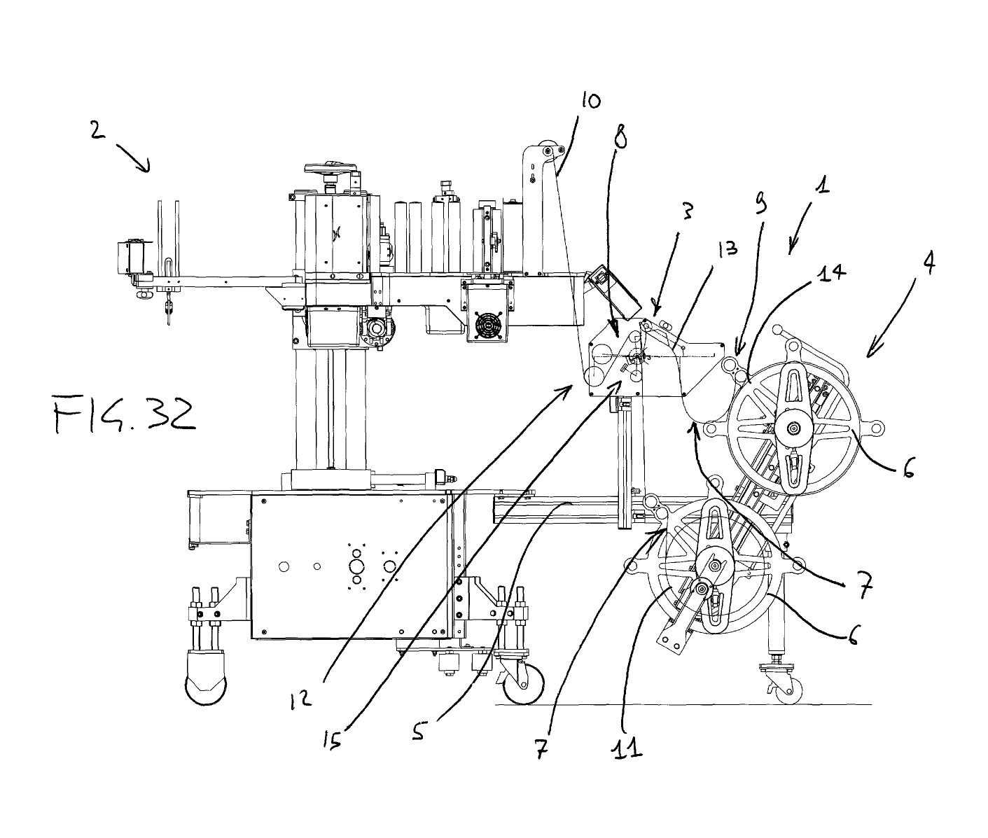

FIG. 27 is an axonometric view of a retaining element of the joining unit of FIGS. 3 to 20;

FIG. 28 is an axonometric view of an element for controlled web feeding, of the joining unit of FIGS. 3 to 20;

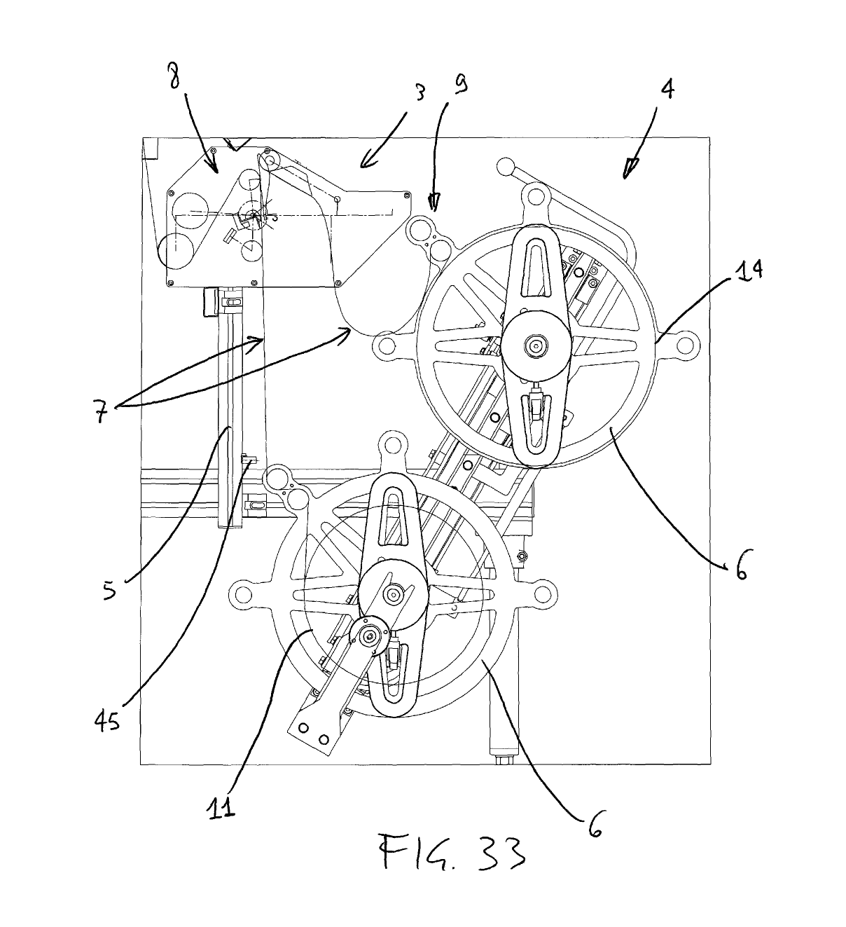

FIG. 29 is a side view of the element of FIG. 28 seen from the right;

FIG. 30 is a top view of the element of FIG. 28;

FIG. 31 is a cross-section of the element of FIG. 30 according to the line XXXI-XXXI;

FIG. 32 is a side view of the unit of FIG. 1 with some parts shown schematically transparent to illustrate operation of the device according to this invention;

FIG. 33 shows an enlarged detail of FIG. 32;

FIG. 34 is an enlarged view of the part of FIG. 33 relating to the operating zone where joining takes place;

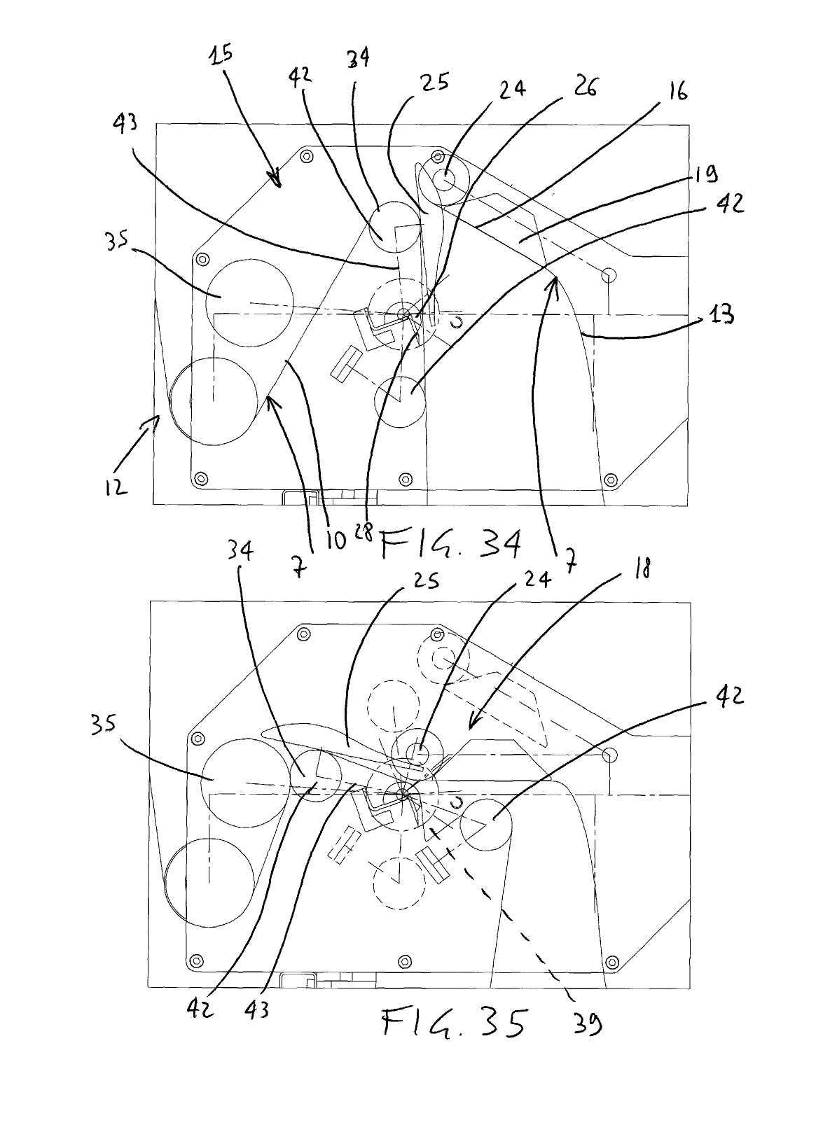

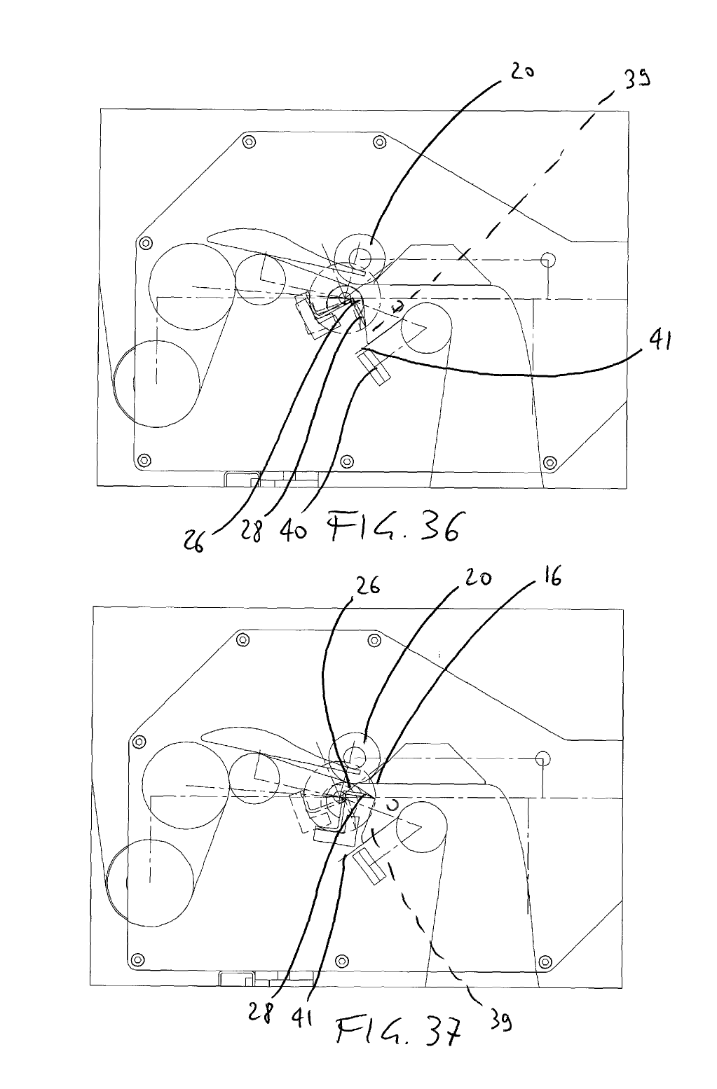

FIGS. 35 to 40 show the joining unit of FIG. 34 during a first series of steps relating to operation of the device;

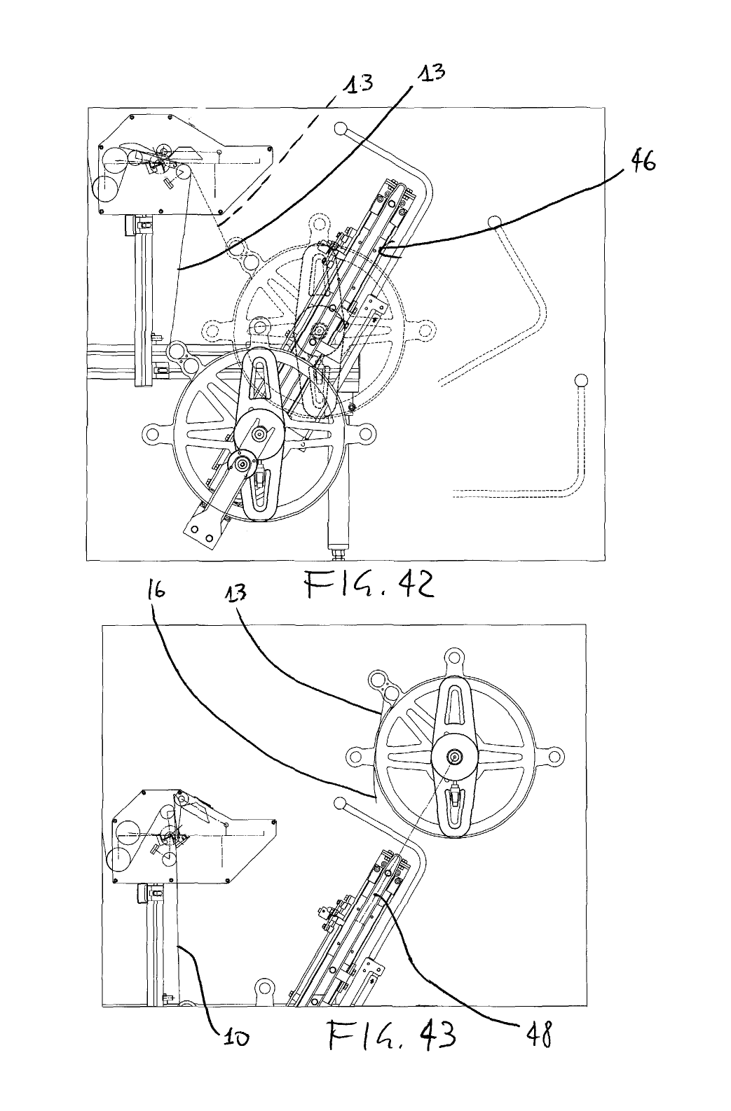

FIGS. 41 to 44 and 47 show further steps of operation of the device and enlarged views of various details of the joining unit of FIG. 33;

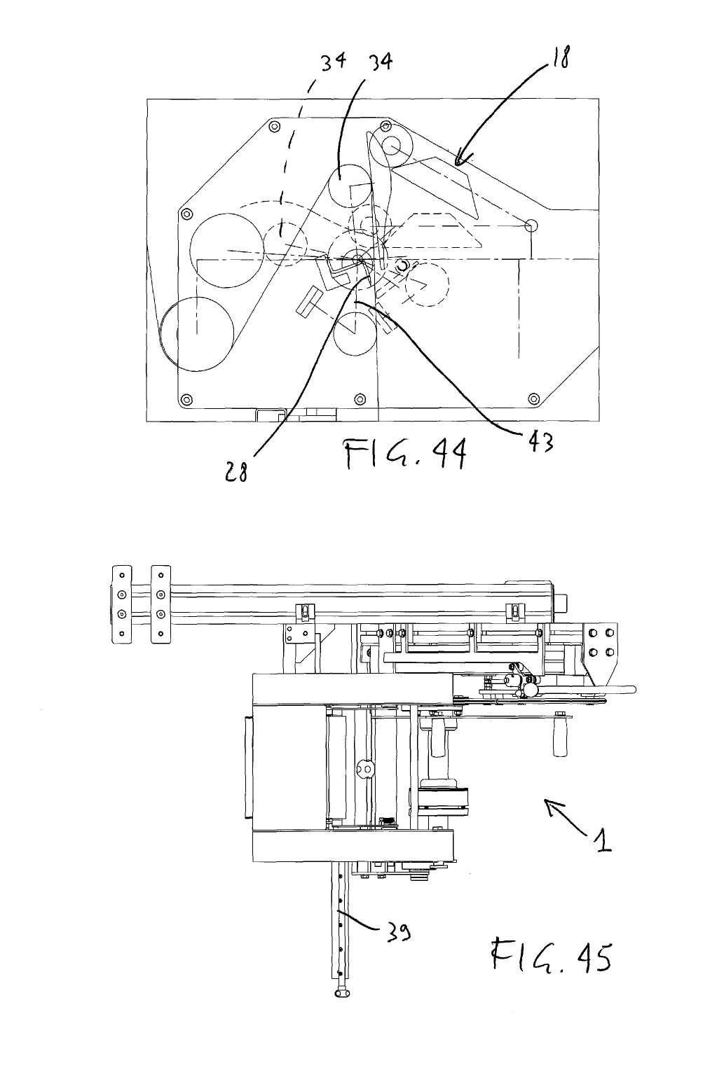

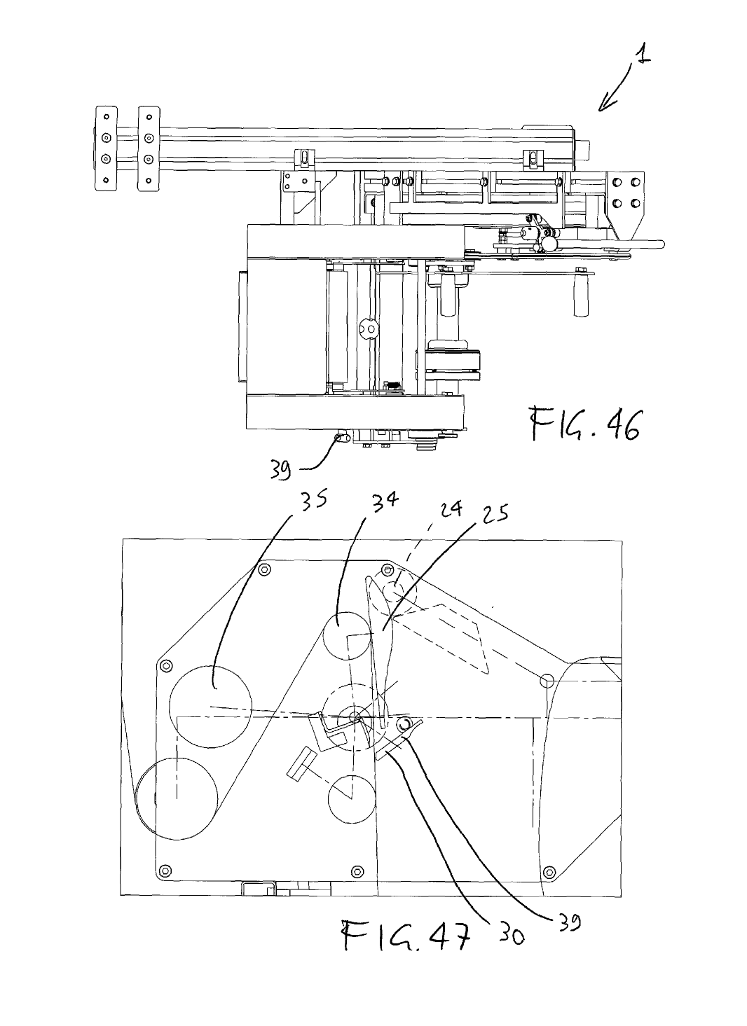

FIGS. 45 and 46 are top views of what is visible respectively in FIGS. 44 and 47;

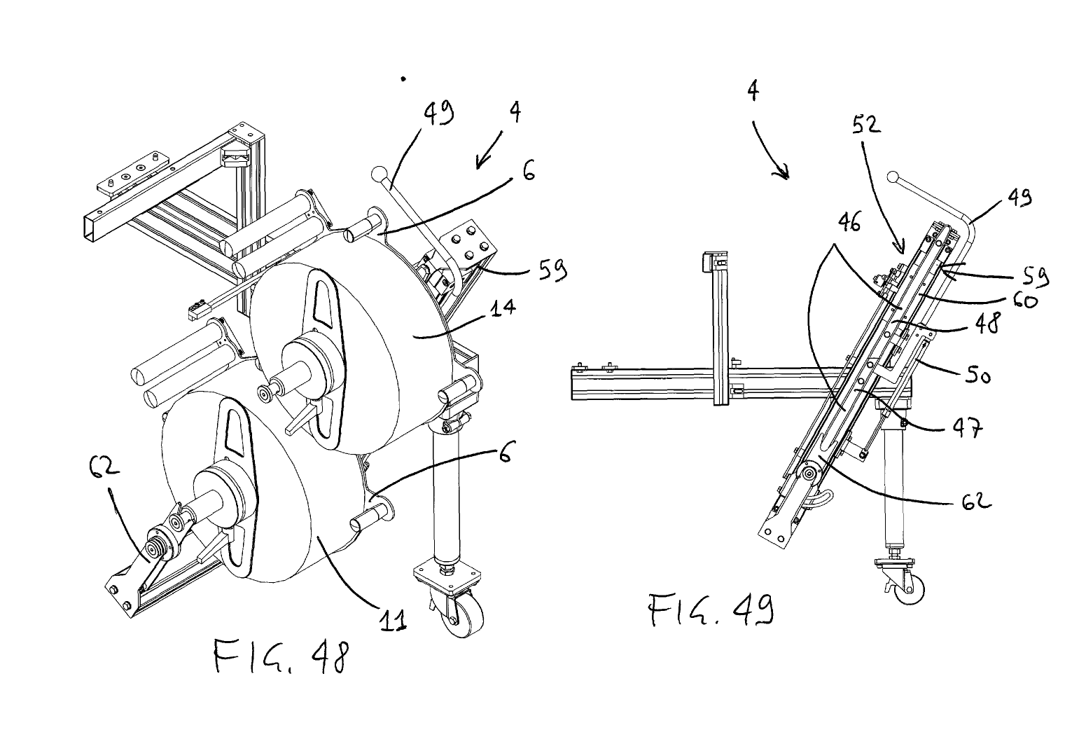

FIG. 48 is an axonometric view, also showing the reels of web, of a supporting unit of the device of FIG. 2;

FIG. 49 shows the supporting unit of FIG. 48 without the reels and the related supports;

FIGS. 50 and 51 are respectively an axonometric and a front view of a part of a positioning unit of a reel support of the supporting unit of FIG. 48;

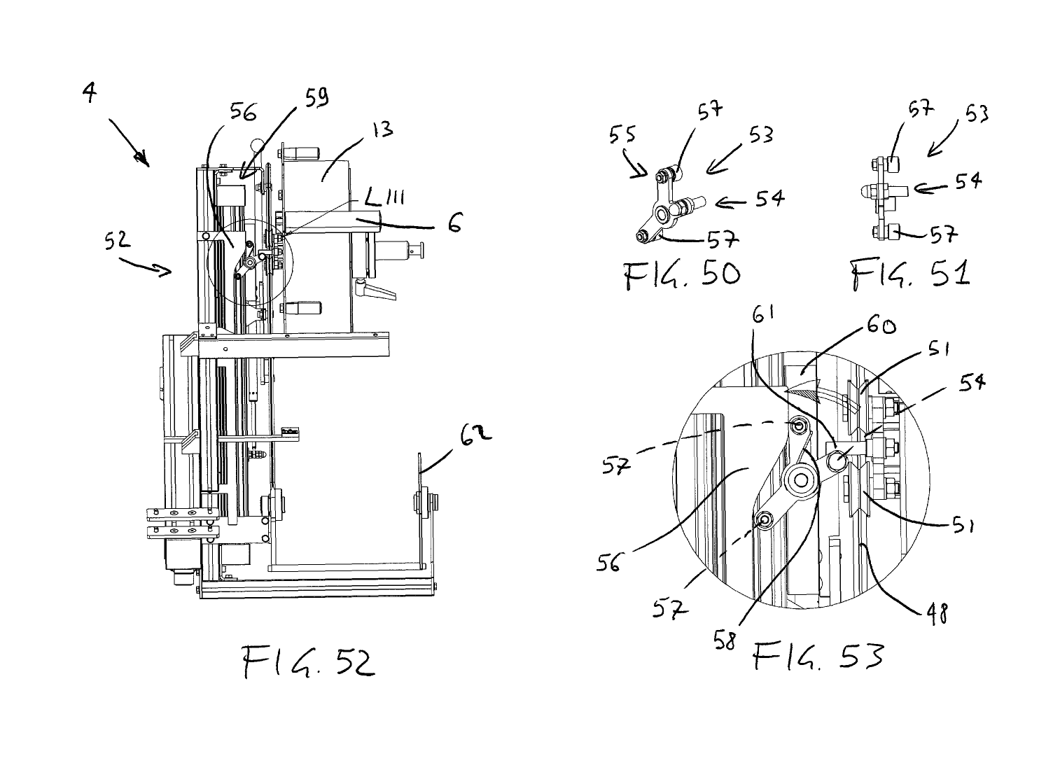

FIGS. 52, 54, 56, 58, 60, 62 and 64 show perpendicularly to a guide of the device, operation of the supporting unit of FIG. 48 concerning the movement of a support on it;

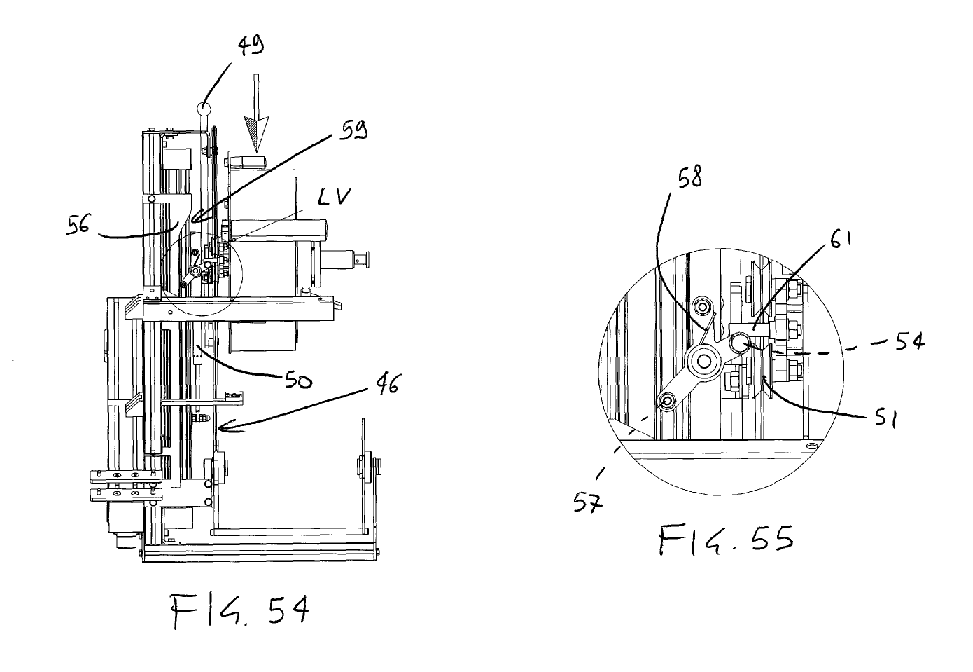

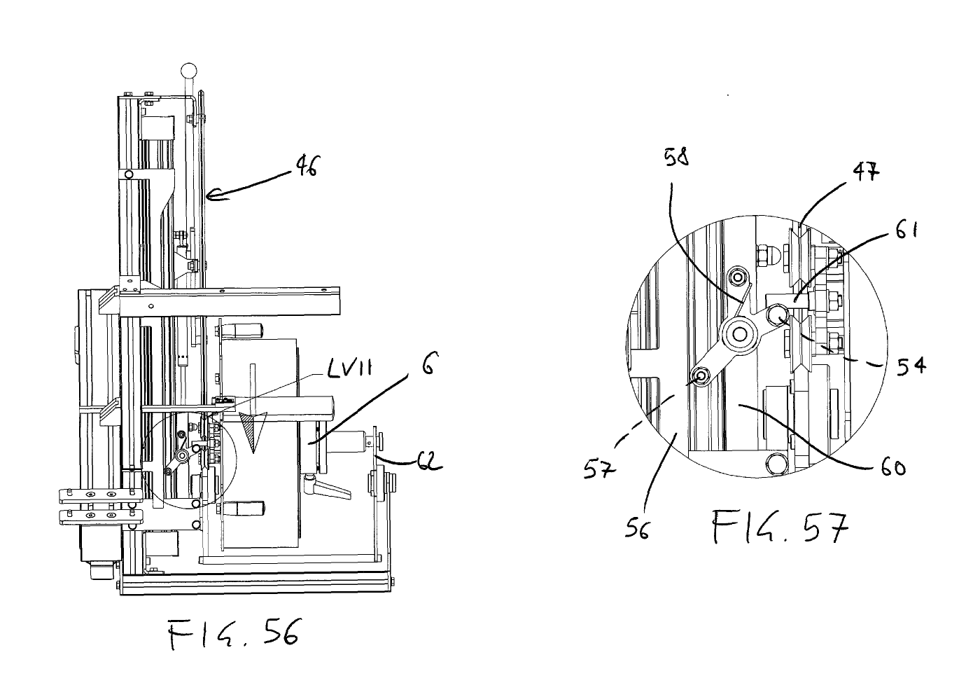

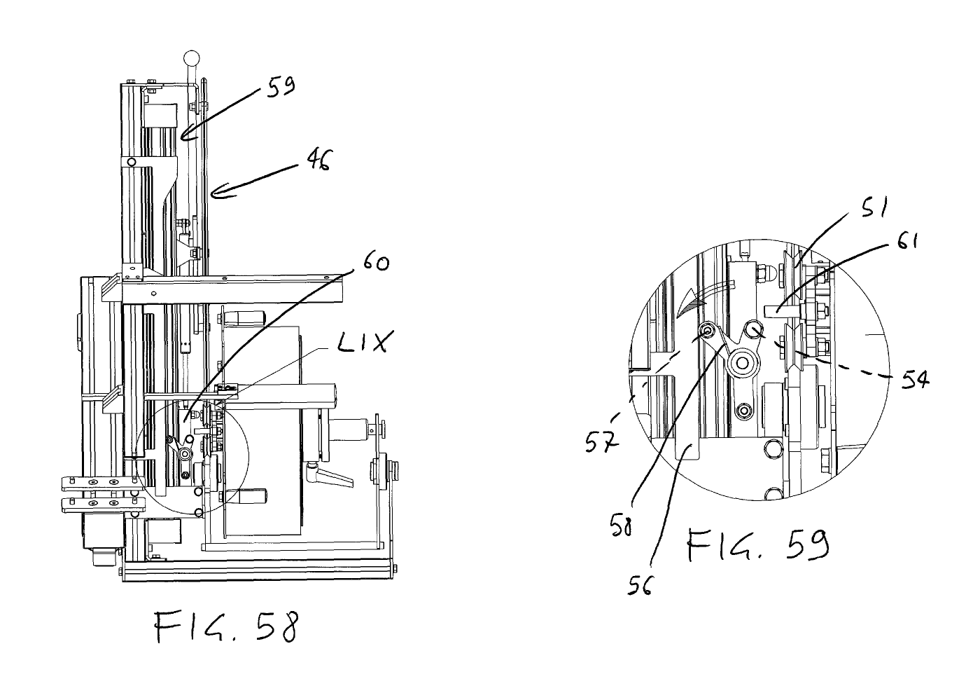

FIGS. 53, 55, 57, 59, 60, 63 and 65 are respectively enlarged views of LIII, LV, LVII, LIX, LXI, LXIII and LXV of FIGS. 52, 54, 56, 58, 60, 62 and 64;

FIGS. 66 to 69 are side views as in FIG. 49, of the steps relating to removal of a support from the supporting unit of FIG. 48.

With reference to the accompanying drawings the numeral 1 denotes in its entirety a device for joining webs with self-adhesive labels to be supplied to a labelling machine, made according to this invention. Hereinafter, it will be referred to simply as the device 1.

It should also be noticed that, hereinafter, when reference is made to a line of extension of three-dimensional objects, it will always refer to their main line of extension, that is to say, the one parallel to which the objects have their maximum length.

FIGS. 1 and 32 show the device 1 connected to a labelling unit 2 of a labelling machine. Obviously, this invention relates to the device 1 in itself, to a labelling unit 2 equipped with the device 1 and to the entire labelling machine equipped with the device 1. However, since the labelling unit 2 visible in the accompanying drawings is in itself of the known type, it will not be described in further detail herein.

The subject matter of the various inventive aspects of this invention (in fact, as seen below, there are many inventive aspects and some of them are potentially even independent) is shown in its entirety in FIG. 2. In particular, in the device 1 of FIG. 2 it is possible to identify two units, a joining unit 3 where joining of the two webs actually takes place, and a supporting unit 4 which supports the reels. The joining unit 3 is illustrated on its own (except for the outer casing) in FIG. 3. The supporting unit 4 is illustrated on its own in FIG. 48. Since the joining unit 3 may be made according to this invention even irrespective of whether or not a supporting unit 4 according to this invention is used, and since the supporting unit 4 may also be used with joining units 3 other than that which is the subject matter of this invention, the two units 3, 4 must be considered as independent aspects of this invention which could also be the subject matter of specific divisional patent applications.

Therefore, hereinafter the joining unit 3 will be described first, then the supporting unit 4, it being understood that according to all of the inventive aspects of this invention the device 1 always comprises a supporting structure 5, at least two supports 6, each for supporting a reel of web with self-adhesive labels fixed on a first side 7 of it, first guide means 8 and second guide means 9.

The supports 6 are rotatably mounted or mountable on the supporting structure 5, one at a first position (the lower position in the accompanying drawings) and one at a second position (the upper position in the accompanying drawings).

The first guide means 8 define a main feed path for a first web 10 which, in use, extends from a first reel 11 mounted on the support positioned in the first position, to an outfeed section 12 of the device 1.

The second guide means 9 define a secondary feed path for a second web 13 which, in use, extends from a second reel 14 mounted on the support positioned in the second position, to an operating zone 15 identified along the main feed path.

It should be noticed that in the accompanying drawings the main feed path and the secondary feed path coincide respectively with the way in which the first web 10 and the second web 13 extend.

The outfeed section 12 is the section where, in use, the web is supplied from the device 1 to the labelling machine (to the labelling unit 2). Advantageously, at least at the operating zone 15 both the first web 10 and the second web 13 are positioned in such a way that the surface, although having a complex shape, is parallel to a reference axis transversal to the main feed path, which in the accompanying drawings is horizontal, and with the sides positioned in the same way. In this way, if seen parallel to the reference axis, the main and secondary feed paths and the first web 10 and the second web 13 substantially appear to be a curved line.

The joining unit 3 is substantially constituted of joining means mounted on the supporting structure 5 at the operating zone 15, which are designed, in use, to join a starting end 16 of the second web 13 to a final end 17 of the first web 10, by pressing the final end 17 of the first web 10 against an adhesive element (which cannot be made out in the accompanying drawings) fixed to the starting end 16 of the second web 13 (the adhesive element may be applied on the second web 13 either manually as in the embodiment illustrated in the accompanying drawings, in which all of the positioning of the second reel 14 and of the second web 13 along the secondary feed path must be performed by the operator, or automatically). The joining means in turn comprise first a web retaining element 18 which is mounted at an end portion of the secondary feed path.

The retaining element 18, in use, is designed to selectively retain the starting end 16 of the second web 13 in the absence of stresses or to allow uncoupling of the starting end 16 of the second web 13 following a pulling action applied on it after at least partial joining of the first web 10 and the second web 13.

The retaining element 18 is shown on its own in FIG. 27, and in the embodiment illustrated it comprises a panel 19 equipped with retaining hooks for the second web 13 (not illustrated, since they are of the known type—however, in other embodiments they may be substituted with other elements such as a suction system), and an idle counter roller 20 where in use the adhesive element is positioned. Both are advantageously supported by two parallel arms 21, one end of which pivots at the supporting structure 5. Preferably, the retaining element 18 is rotatable relative to the supporting structure 5 between a series of positions for joining, illustrated in the accompanying drawings and described below, and a web fixing position (not illustrated) in which it is rotated through approximately 180° relative to the moment when joining occurs. The web fixing position is intended to facilitate precise fixing of the second web 13 on the panel 19. A knob 22 helps the operator to move the retaining element 18 into this position, overcoming the opposition of a return spring 23 which tends to return the retaining element 18 towards the operating zone 15 (to be precise, the spring is mounted in such way that it is stretched to its maximum length at an intermediate point of the arc of rotation of the retaining element 18 between the positions at the operating zone 15 and the web fixing position, thereby guaranteeing stable positioning of the retaining element 18 in both situations). Advantageously, as is explained in more detail below, the retaining element 18 also comprises a follower 24 (advantageously a fixed or idle roller coaxial with the idle counter roller 20) slidably coupled to a cam element 25 movably mounted on the supporting structure 5. This aspect is also described in more detail below.

The device 1 comprises a pressure element 26 positioned in the operating zone 15 on the opposite side of the main feed path to the retaining element 18.

In the embodiment illustrated, the pressure element 26 extends mainly transversally to the main feed path and advantageously parallel to the reference axis.

As shown in FIGS. 22 to 26, in the embodiment illustrated the pressure element 26 is constituted of a part of a cylindrical surface rotatably connected to the supporting structure 5 according to an axis of rotation which is eccentric relative to the axis of the cylinder on which the surface lies. In this way, after rotation, in each angular position it is possible to obtain a radial movement of the cylindrical surface. In the case illustrated all of the angular positions in which the pressure element 26 presses against the retaining element 18 (even overcoming the force of the return spring 23) can be identified as part of the operating position in accordance with this invention as defined below.

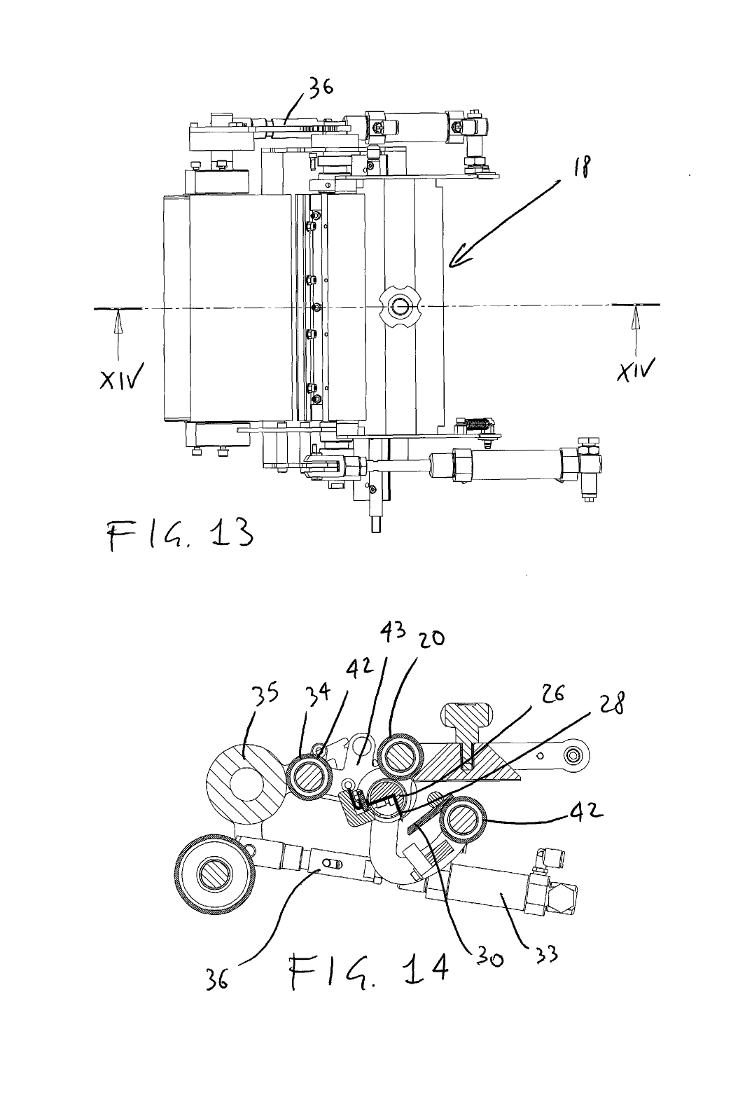

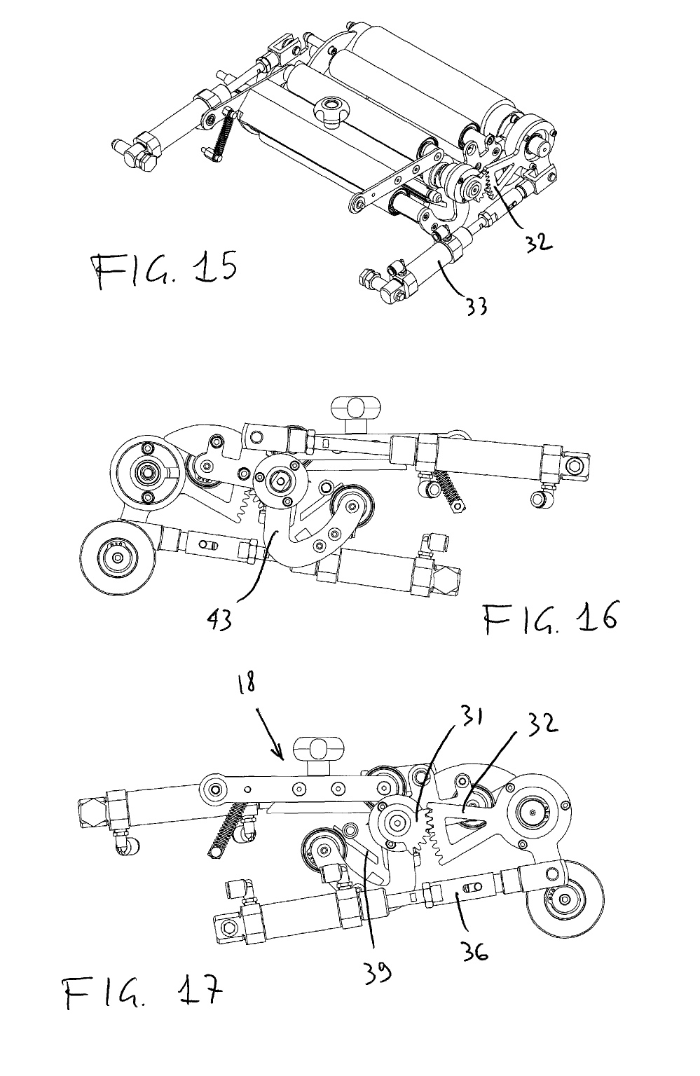

According to this invention, at least one of either the retaining element 18 or the pressure element 26 is movable, relative to the other, between a non-operating position (FIGS. 14, 35, 36) in which the two are at a distance from one another and, in use, the first web 10 can freely run between them, and an operating position (FIGS. 18, 37) in which the pressure element 26 is pressed onto the retaining element 18 (advantageously onto the idle counter roller 20) for, in use, pressing the final end 17 of the first web 10 onto the adhesive element fixed to the starting end 16 of the second web 13 which is retained by the retaining element 18. Advantageously, the maximum pressure is achieved in the angular position of the pressure element 26 in which the latter presses on the idle counter roller 20 pushing the retaining element 18 away from the position in which it is located in the non-operating position, towards the web fixing position, overcoming the force applied by the return spring 23. As shown in FIG. 39, in this condition the follower 24 is at a slight distance from the cam element 25.

The device 1 also comprises at least one cutting element 27, also mounted on the supporting structure 5 along the main feed path, and upstream of the pressure element 26. The cutting element 27 is movable between a non-interference position (FIGS. 10, 14, 34, 35) in which, in use, it does not interfere with the first web 10 being fed along the main feed path, and a cutting position (FIGS. 18, 36 to 39) in which it interferes with main feed path so as to cut the first web 10.

In the preferred embodiment, the cutting element 27 comprises a blade 28 and a stop element 29 both extending transversally to the main feed path. When the cutting element 27 is in the cutting position, the blade 28 is advantageously in contact with the first web 10 and causes a cusp in the main feed path, whilst the stop element 29 is in contact against a contact element 30 for retaining between itself and the contact element 30 the first web 10. In fact, in this way, pulling of the first web 10 along the main feed path causes it to tear against the blade 28.

In the preferred embodiment illustrated in the accompanying drawings, the pressure element 26 and the cutting element 27 are fixed to one another (FIGS. 22 to 26). In particular, the blade 28 is saw-toothed and projects from an edge of the cylindrical surface of the pressure element 26, whilst the stop element 29 is constituted of an L-shaped profile mounted on the outside of the cylindrical surface. In this way, the pressure element 26 and the cutting element 27, together, are rotatably connected to the supporting structure 5 about said eccentric axis of rotation, and the non-operating position of the pressure element 26 corresponds to the non-interference position of the cutting element 27, whilst when the cutting element 27 is in the cutting position the pressure element 26 is in turn in the operating position.

The device 1 also comprises movement means for moving the cutting element 27 from the non-interference position to the cutting position, which in the preferred embodiment also cause simultaneous rotation of the pressure element 26 from the non-operating position to the operating position. In the embodiment illustrated, the movement means comprise a first toothed sector 31 keyed onto said eccentric axis of rotation and which is driven by a corresponding second toothed sector 32 with larger radius, in turn driven to rotate by a first linear actuator 33. However, in the preferred embodiment, both the first linear actuator 33 and the second toothed sector 32 are also part of means for controlled feeding of the first web 10. In fact, according to this invention, the device 1 in general also comprises means for controlled feeding of the first web 10 along the main feed path, which are operatively associated with the movement means for causing controlled feeding of the first web 10 in the operating zone 15 during the movement of the cutting element 27 towards the cutting position.

In the context of this invention, controlled feeding refers to the fact that the first web 10 is fed in a known way which allows one to know with sufficient precision the position of a zone of it which has no labels on it, in such a way as to be able to perform cutting and subsequent joining at said zone which has no labels on it. That result can be achieved in various ways. However, in the preferred embodiment, controlled feeding is carried out by accelerating the first web 10 at a speed which is higher than the maximum speed that it can adopt during normal operation of the labelling machine. In fact, in this way, it is possible to perform the joining without having to slow down production, as is explained in more detail below.

In the embodiment illustrated, the knowledge of the position of the zone which has no labels on it is in reality only implicit. In fact, as already indicated, the controlled feeding means are mechanically synchronised with the movement means, in such a way that a predetermined movement of the web corresponds to a predetermined movement of the cutting element 27 which, advantageously, in the zone where the blade 28 makes contact with the web is practically equal (except for small tolerances). Therefore, it is sufficient to operate the controlled feeding means at the correct moment, to be sure that the blade 28 cuts the first web 10 at the zone in question, as well as advantageously only at the best moment (as is explained below). As described below, the correct moment may be determined using suitable detecting means.

Remaining for the moment on the subject of the controlled feeding means, in the preferred embodiment they comprise first a first roller 34 and a second roller 35, where the first roller 34 is idle and is also part of the first guide means 8. The first roller 34 and the second roller 35 are movable relative to one another between a distal position (FIGS. 10 and 34) in which they are at a distance from each other and the second roller 35 is at a distance from the main feed path, and a proximal position (FIGS. 14, 18 and 35 to 39) in which they are pressed against one another for, in use, clamping between them the first web 10 in such a way as to be able to drag it. The controlled feeding means also comprise means for causing controlled rotation of the second roller 35 when the first roller 34 and the second roller 35 are in the proximal position, which in the preferred embodiment in turn comprise the above-mentioned first linear actuator 33 (preferably of the pneumatic type) and the second toothed sector 32. More precisely, the first linear actuator 33 acts on a cantilever-style projection of the second toothed sector 32 with a sprung damper 36 interposed between them which, considering the high speed of movement of the first linear actuator 33, allows absorption of the residual motion of the first linear actuator 33 after the second toothed sector 32 has reached the end of its stroke (FIGS. 19 and 20).

To allow both normal movement of the first web 10 and controlled feeding of it when required, the second roller 35 is rotatably connected to a supporting element 37 (fixed to or coinciding with the second toothed sector 32 in the embodiment illustrated) by means of a freewheel mechanism 38 which, on one hand, allows it to rotate freely relative to the supporting element 37 according to a first direction of rotation compatible with the direction of running of the first web 10 along the main feed path, and, on the other hand, prevents it from rotating in a second direction which is opposite to the first. Compatible direction of rotation means the direction of rotation which, with the first roller 34 and the second roller 35 in the proximal position and the supporting element 37 stationary, is transmitted to the second roller 35 by the first web 10 advancing towards the outfeed section 12.

In general, the supporting element 37 is in turn rotatable about the same axis of rotation about which the second roller 35 can rotate, and the means for causing the controlled rotation of the second roller 35 comprise an actuator (the above-mentioned first linear actuator 33 in the accompanying drawings) connected to the supporting element 37 to make it rotate according to the first direction of rotation and at a speed which is greater than the maximum speed at which the first web 10 can in use make the second roller 35 rotate (thereby guaranteeing operation of the freewheel block 38).

As already indicated, to decide the above-mentioned correct moment for activation of the means for controlled feeding of the first web 10, the device 1 advantageously comprises detecting means mounted along the main feed path and designed to detect the position of a label on the first web 10, as well as a control unit (not illustrated) operatively connected to the movement means, to the controlled feeding means and to the detecting means, and which controls activation of the movement means and the controlled feeding means depending on what is detected by the detecting means. In particular, the detecting means may send a signal to the control unit at the moment when they detect the transit at a predetermined point of the main feed path, of a front or rear side of a label. Advantageously, this is the label immediately upstream of the cutting element 27 along the main feed path. In the preferred embodiment, in particular, the detecting means comprise a label detacher 39 (that is to say, an element similar to those commonly used on labelling units which, acting on the second side of the first web 10, causes a sudden inversion of its direction of feed and consequent detachment of the label from the first side 7) extending transversally to the main feed path, and a photocell 40 designed to detect an edge 41 of a label which in use is detached from the web at the detacher 39. Moreover, at least one of either the detacher 39 or the main feed path can be switched between a passive position or configuration in which the detacher 39 is uncoupled from the main feed path, and an active position or configuration in which the detacher 39 is part of the first guide means 8 and causes the sudden inversion in the main feed path designed to cause the labels to become detached. Depending on the embodiments, the detacher 39 may be movable in such a way as to cause said switching, or, as in the embodiment illustrated, it is the main feed path which switches its configuration by a movement of the first guide means 8. In fact, in the accompanying drawings, the first guide means 8 comprise two idle rollers 42 mounted on an oscillating rocker arm 43 (FIG. 21) which is movable relative to the detacher 39 between a first position and a second position.

When the rocker arm 43 is in the first position (FIGS. 10 and 34) the passive position or configuration is achieved. When it is in the second position (FIGS. 14, 18, 35 to 39) the active position or configuration is achieved. Only after movement of the rocker arm 43 from the first position to the second position is adhesion of the web to the detacher 39 achieved and therefore the possibility of detaching a label.

In the preferred embodiment, one of the two idle rollers 42 mounted on the rocker arm 43 also constitutes the first roller 34 of the controlled feeding means. Consequently, when the rocker arm 43 passes from the first position to the second position, advantageously both the passage of the main feed path from the passive position or configuration to the active position or configuration, and the passage of the first roller 34 and the second roller 35 from the distal position to the proximal position are achieved. The movement of the rocker arm 43 is guaranteed by a second linear actuator 44. The related activation is in contrast controlled by the control unit when it receives, from a sensor 45 (such as a photocell—FIG. 33) positioned along the main feed path, sufficiently upstream of the operating zone 15, a signal indicating that the end of the first reel 11 has reached it. Said signal is preferably generated when the final edge of the first web 10, after being unwound from the support positioned in the first position, passes beyond the sensor 45.

Moreover, in the embodiment illustrated, the axis of rotation of the rocker arm 43 corresponds to the joint axis of rotation of the cutting element 27 and the pressure element 26, even if the two rotations are completely independent.

It should also be noticed that in the embodiment illustrated the detacher 39 also constitutes the contact element 30 for the stop element 29.

As already indicated, in the preferred embodiments the retaining element 18 comprises a follower 24 slidably coupled to a cam element 25 movably mounted on the supporting structure 5, in such a way as to cause the movement of the retaining element 18 between the non-operating position and a safe position in which it is further from the main feed path than when it is in the non-operating position. In the embodiment illustrated in which the follower 24 is only resting on the cam element 25, the contact between the two is guaranteed by the return spring 23.

As is clearly visible in FIG. 21, in the preferred embodiment the cam element 25 is fixed to the rocker arm 43. When the rocker arm 43 is in its first position the cam element 25 keeps the retaining element 18 in the safe position (FIGS. 7, 10 and 34). Whilst when the rocker 43 is in the second position, the cam element 25 allows positioning of the retaining element 18 in the non-operating position (FIGS. 20 and 35 to 39. It is the return spring 23 which brings it into the non-operating position).

Operation of the device 1, with reference to the joining unit 3, is schematically illustrated in FIGS. 34 to 40 and three-dimensionally in FIGS. 3 to 20. It should be noticed that in FIGS. 34 to 40, on one hand the various parts are schematically indicated and are not always entire or all there, and on the other hand, in the same drawings the same part may be represented several times with different lines, where a continuous line indicates the actual position at that moment, and a dashed line indicates a previous position.

Initially (FIGS. 3 to 10, 33 and 34), the first reel 11 is being unwound at the operating speed thanks to the pulling applied by the labelling unit 2, and the first web 10 follows the main feed path with the rocker arm 43 in the first position and the first roller 34 and the second roller 35 in the distal position. Consequently, the retaining element 18 is kept in the safe position by the cam element 25. Moreover, the pressure element 26 is in the non-operating position, and the cutting element 27 is in the non-interference position. The second reel 14 is in position and the starting end 16 of the second web 13, with the adhesive element on it, is retained on the retaining element 18 with its first side —7 facing towards the second side of the first web 10 which is running along the main feed path.

When the first reel 11 ends and the final edge of the first web 10 passes beyond the sensor 45, the sensor sends the signal to the control unit which activates the second linear actuator 44, which extends and moves the rocker arm 43 into the second position (FIGS. 11 to 14 and 35);
consequently:
the first roller 34 and the second roller 35 move to the proximal position and clamp between them the first web 10;
the cam element 25 allows the passage of the retaining element 18 to the non-operating position; and
the main feed path and the detacher 39 adopt the active position or configuration; the second side of the web is partly wrapped on the detacher 39, causing the cusp in the main feed path.

At this point, as soon as the front side of a new label reaches the cusp, the label starts to detach from the web until it is detected by the photocell 40. At that point the control unit activates the second linear actuator 44 which begins moving the second toothed sector 32. Consequently, on one hand controlled feeding of the web begins, and on the other hand rotation of the cutting element 27 and the pressure element 26 begins. At the moment when the blade 28 touches the first web 10 (FIG. 36) the pressure element 26 is still far from the idle counter roller 20. Then, the blade 28 acts on the first web 10, further modifying the main feed path. Advantageously, the cutting element 27, the related movement means and the controlled feed means are sized in such a way that the movement of the blade 28 and of the first web 10 at the point of mutual contact occur practically at the same speed in such a way that initially the cut is not made.

Before the cutting element 27 reaches the end of its stroke (and before the cut is made) the pressure element 26 thanks to its eccentricity presses the second side of the first web 10 onto the adhesive element retained by the retaining element 18 at the idle counter roller 20, thereby joining the two webs (FIGS. 15 to 18 and 37).

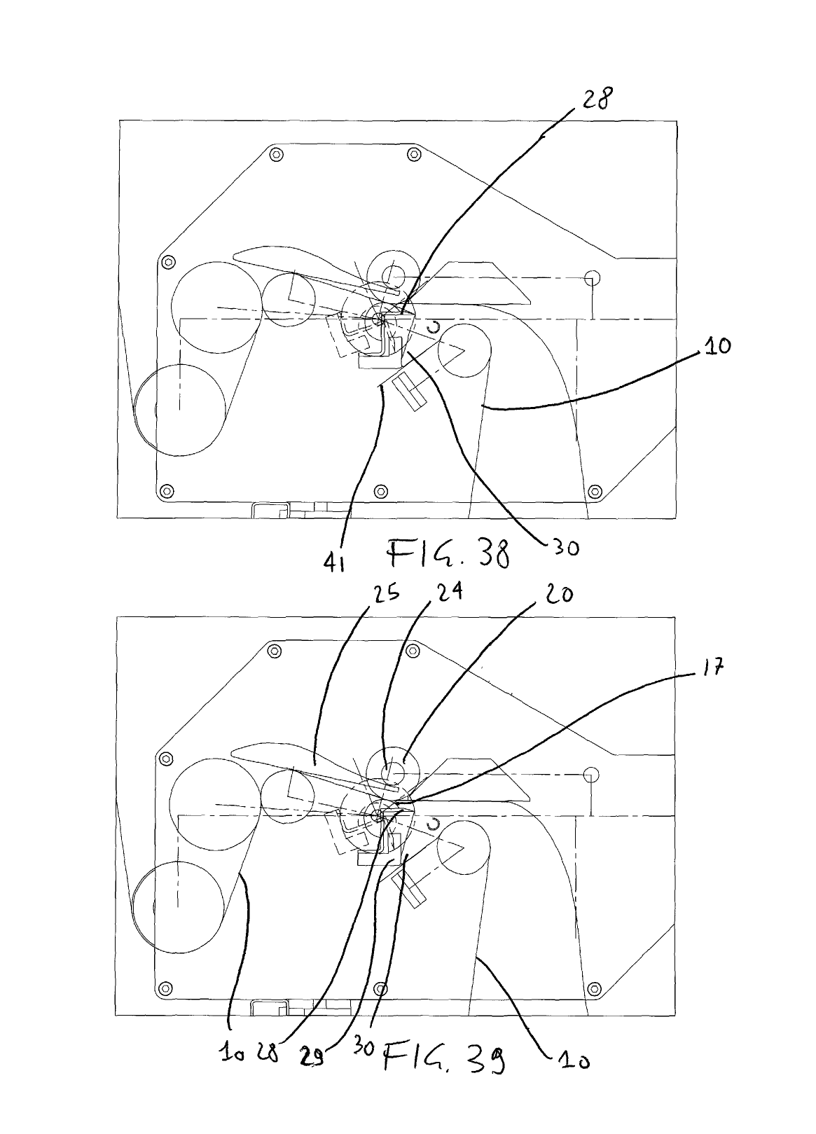

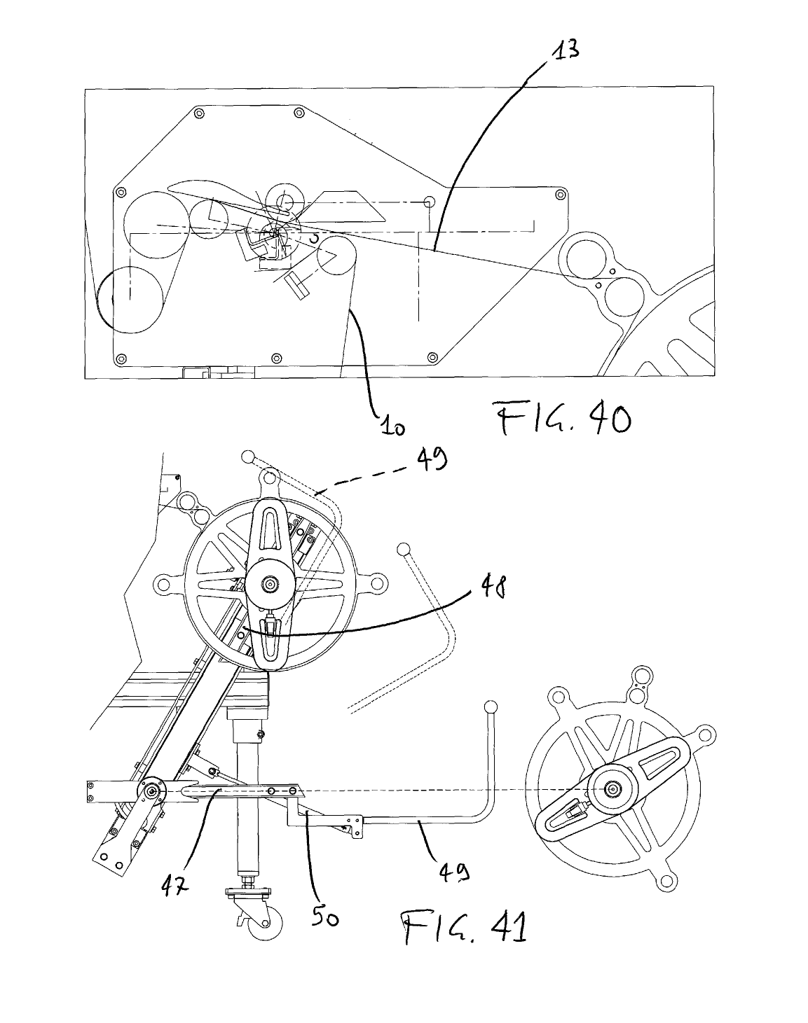

The further rotation of the second toothed sector 32 and of the first toothed sector 31 then brings the cutting element 27 to the end of its stroke with the stop element 29 in contact on the detacher 39 (FIG. 38) and the pulling of the second web 13 together with the first web 10 begins

At that point, the first toothed sector 31 and the second toothed sector 32 stop, and the residual motion of the first linear actuator 33 is absorbed by the sprung damper 36 (FIGS. 19 and 20). The subsequent pulling on the first web 10 causes cutting of the first web 10 (FIG. 39). Thanks to the sizing of the various parts, the position of the cutting point is selected in such a way that the final end 17 of the first web 10 created in this way is not superposed on the starting end 16 of the second web 13 but only on the adhesive element (obviously the positioning of the second web 13 on the retaining element 18 must be correspondingly precise). The passage of the final end 17 of the first web 10 between the pressure element 26 and the idle counter roller 20 causes final adhesion of the adhesive element to the first web 10. Finally, the subsequent pulling causes the second web 13 to be released from the retaining element 18.

At this point, the first linear actuator 33 is operated to return the cutting element 27 and the pressure element 26 respectively to the non-interference position and to the non-operating position (FIG. 40). Before continuing the description of operation of the embodiment illustrated of the device 1 according to this invention, it is necessary to describe the supporting unit 4.

According to the second independent inventive aspect of this invention, relating to the supporting unit 4, on one hand the positions of the two supports 6 can be inverted, and, on the other hand, a support 6 positioned in the second position can be moved to the first position, allowing, during the entire movement, unwinding of the second web 13 from the second reel 14 and its free feeding from the second reel 14 towards the operating zone 15. In this way, when the movement is complete, it is possible to position a new reel on the other support 6 placed in the second position and so be in the starting situation. Consequently, in theory it would be possible to keep fitting new reels, joining them to the previous reels, without interruptions. For that purpose, in an embodiment not illustrated the supporting structure 5 comprises a frame rotatable about an axis which, in use, is parallel to an axis of rotation of the reels mounted on the supports 6, and the supports 6 are mounted on said frame on opposite sides of the axis of rotation of the frame. In this way, the movement of one support 6 from the first position to the second position and of the other support 6 from the second position to the first position is achievable by rotating the frame.

In the embodiment illustrated in which the detacher 39 is stationary, and it is the rocker arm 43 which moves, in order to be able to return precisely to the starting configuration it is however also necessary for the detacher 39 to also be movable transversally to the main feed path, between an inserted position in which it is opposite the main feed path (FIG. 46), and an extracted position in which it is not opposite the main feed path (FIG. 45) and therefore allows migration of a web from the secondary feed path to the main feed path during the passage of the related support 6 from the second position to the first position. In the embodiment illustrated the movement of the detacher 39 comprises its manual extraction along the related main line of extension. However, in other embodiments it may also be achieved in a different way (in particular if it were the detacher 39 which moves between the passive and active position or configuration) as well as automatically. If, in contrast, the detacher 39 were not present and the detecting means were of a different type, a support 6 could pass from the second position to the first position during unwinding of the web without problems.

Returning to the supporting unit 4 illustrated in the accompanying drawings, in it the supporting structure 5 comprises a guide 46, advantageously straight, on which the supports 6 are slidably mounted. Therefore, each support 6 can pass from the second position to the first position by sliding along the guide 46.

In contrast, for the opposite passage of the other support 6, that is to say, from the first position to the second position, the guide 46 advantageously comprises two separate portions, a first portion 47 which defines the first position for the supports 6 and a second portion 48 which defines the second position for the supports 6. At least the first portion 47 is rotatable between an aligned position (FIGS. 42 and 49) in which it is aligned with the second portion 48 and allows the passage of a support 6 from the second portion 48 to the first portion 47, and a rotated position (FIG. 41) in which it is not aligned with the first portion 47 and allows the removal of a support 6 from it, preferably by simply pulling it off. Advantageously, the first portion 47 pivots at the supporting structure 5 according to an axis of rotation coinciding with that of the first reel 11 positioned on the support 6 in the first position. The second portion 48 in turn, on the opposite side to the first portion 47, is open for allowing one of the supports 6 to be coupled to it (FIG. 43).

In the embodiment illustrated, the movement of the first portion 47 may be performed using a manually operated lever 49 connected to an air spring 50. However, in other embodiments it may be performed automatically and/or be motor-driven.

In the preferred embodiment, on one hand the guide 46 is constituted of a rail on which the supports 6 are slidably coupled by means of four V-shaped pulleys 51 which are positioned on both sides of the rail, and on the other hand it comprises at least one vertical component of extension (in the accompanying drawings it is in fact set at an angle of approximately 60° to the horizontal plane).

To facilitate the movement of the supports 6 and holding in the second position, the device 1 advantageously comprises at least one positioning unit 52, movable parallel to the guide 46 between an upper position in which it retains a support 6 positioned in the second position, a lower operating position in which it can support a support 6 positioned substantially in the first position, and a lower non-operating position in which it is positioned lower than the lower operating position and is uncoupled from the support 6 in the first position.

In the preferred embodiment, the positioning unit 52 also comprises a body 53 (FIGS. 50 and 51) comprising a resting portion 54 and a following portion 55.

The resting portion 54 (constituted of a cantilever-style pin in the accompanying drawings) is designed to interact with a support 6 so as to sustain it.

In contrast, the following portion 55 is slidably associated with a cam portion 56 of the supporting structure 5. Advantageously, the following portion 55 comprises two following rollers 57 which are at a distance from one another and from an axis of rotation of the body 53.

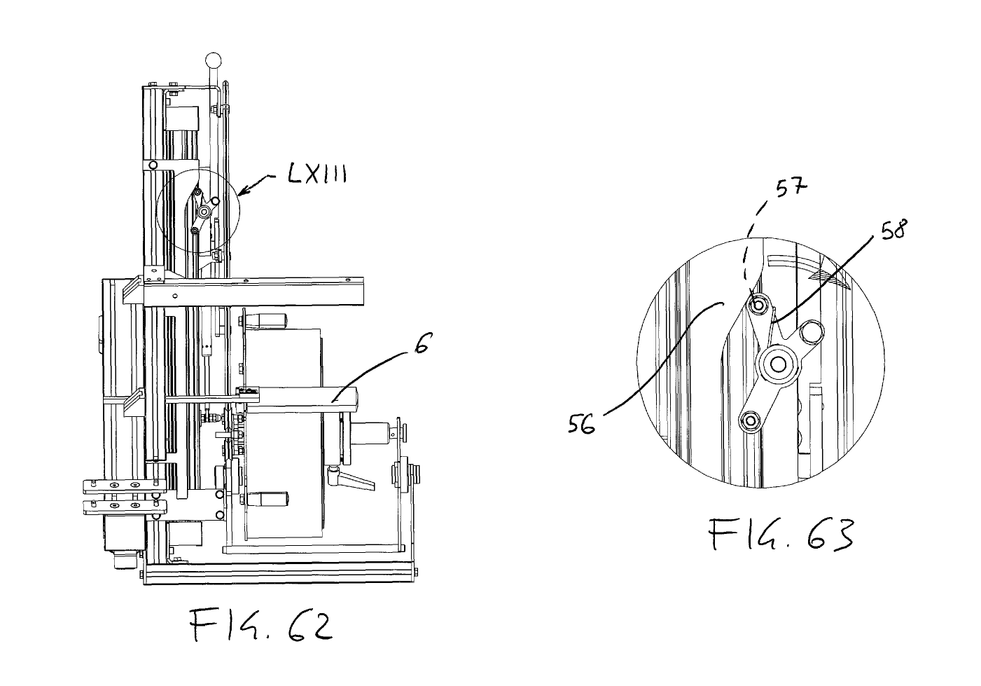

In fact, the body 53 is rotatable about an axis of rotation which translates with the body 53 and which is transversal to a main line of extension of the guide 46. In particular, the body 53 is rotatable between a sustaining position in which the resting portion 54 can interact with a support 6 mounted on the guide 46 so as to sustain it (FIG. 53), and a home position in which the resting portion 54 cannot engage with a support 6 associated with the guide 46 (FIG. 61). There are also elastic means 58 (a torsion spring in the accompanying drawings) associated with the body 53 for pushing it towards the home position. In contrast, the cam portion 56 in turn causes forced positioning of the body 53 in the sustaining position at least at the positioning unit 52 upper position, whilst it allows it to rotate towards the home position at least near to and at the lower operating position and between the lower operating position and the lower non-operating position. In fact, in this way it is possible to perform the translation of the positioning unit 52 from the non-operating home position to the sustaining position even when a support 6 is present in the respective first position.

In the accompanying drawings the movement of the body 53 along the cam portion 56 is achieved by means of a cylinder without a rod 59, equipped with a slide 60 to which the body 53 is rotatably connected.

The sequence of steps for the passage of a support 6 from the second position to the first position (once the latter is free) and for preparing the device 1 to receive another support 6 in the second position is illustrated in FIGS. 52 to 65.

Initially (FIGS. 52, 53), the body 53 is in the upper position and, thanks to the interaction of the cam portion 56 with the following portion 55, in the sustaining position, with the resting portion 54 interacting with a corresponding resting element 61 fixed to the support 6, sustaining it. During the entire descent of the body 53 to the lower operating position, the weight of the support 6 overcomes the resistance of the elastic means 58 and holds the body 53 rotated with the following portion 55 only partly coupled to the cam portion 56. Relative to a lower following roller 57 of the following portion 55, the resting portion 54 is in fact positioned on the other side of a vertical plane passing through the pivoting point of the body 53.

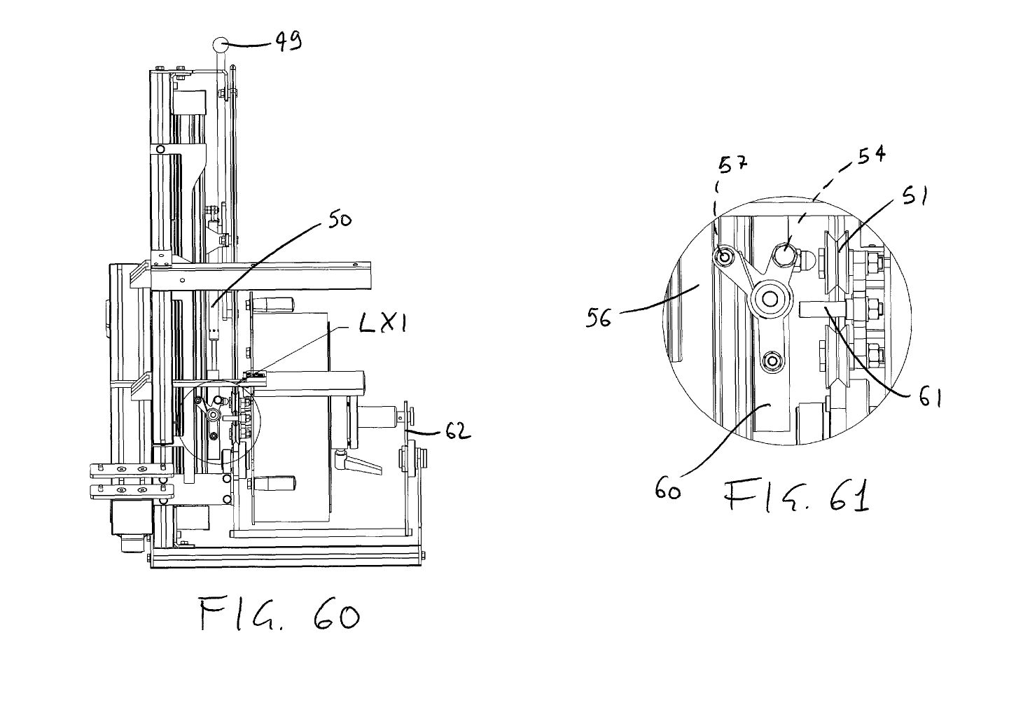

When the body 53 reaches the lower operating position, the support 6 reaches the end of its stroke corresponding to the first position, and it engages in a suitable fork 62 fixed to the guide 46 (FIG. 56), and advantageously fixed to the first portion 47 for rotating with it (FIG. 67). At that point, the further descent of the body 53 frees the resting portion 54 and the elastic means 58 can return the body 53 to the home position. At this point, the resting portion 54 is not aligned with the resting element 61 fixed to the support 6 which is in the first position (FIGS. 58, 59). Therefore it is possible to return the positioning unit 52 towards the upper position without there being any interaction between the resting portion 54 and the resting element 61 of the support 6 in the first position (FIGS. 60, 61).

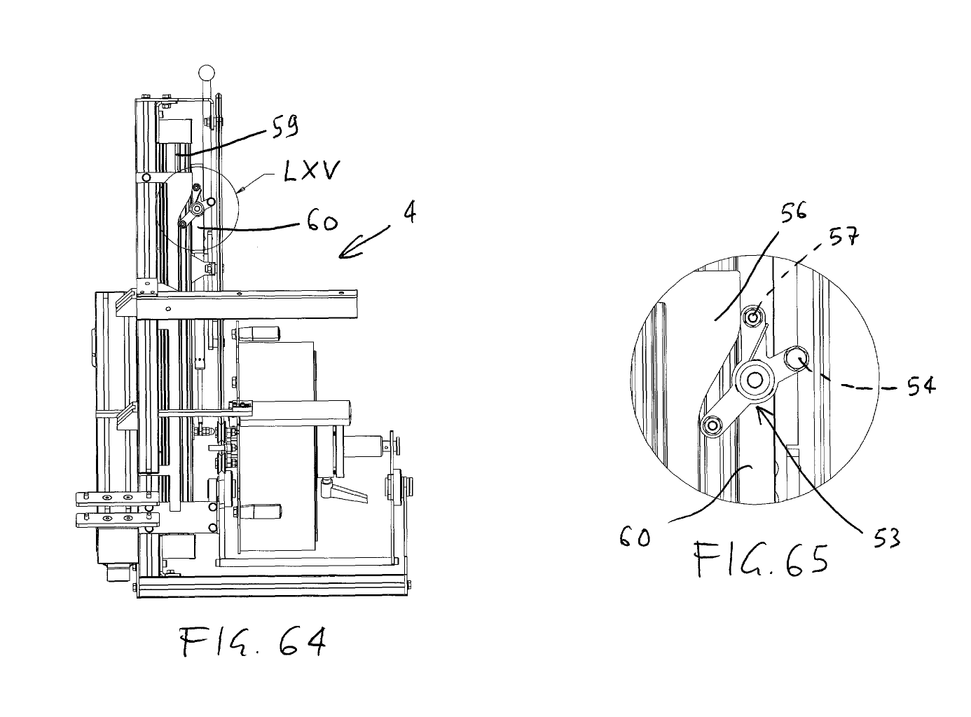

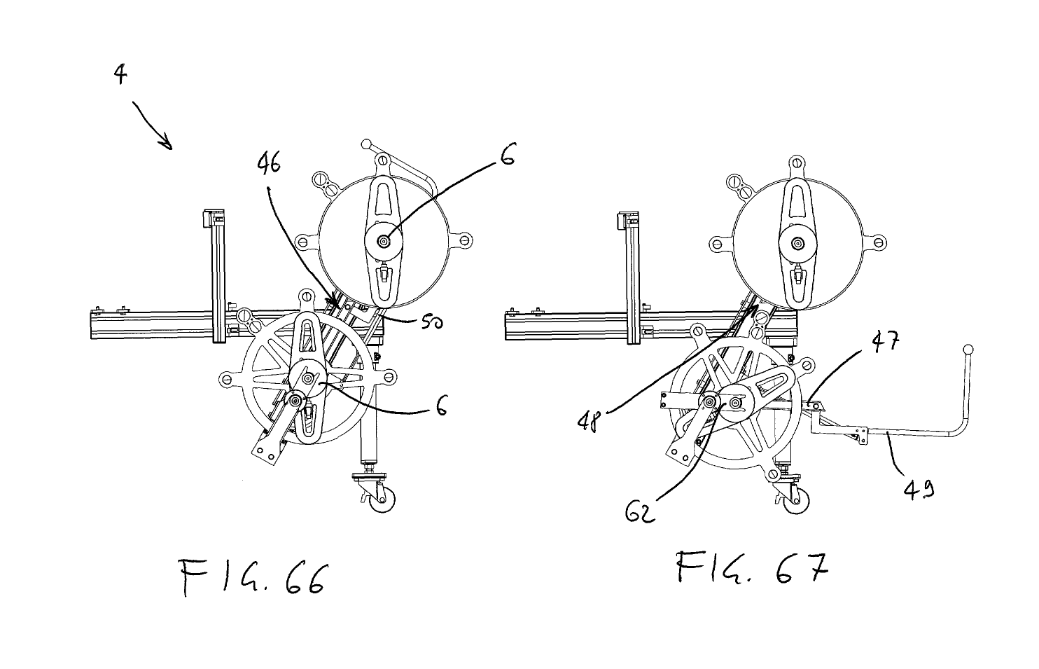

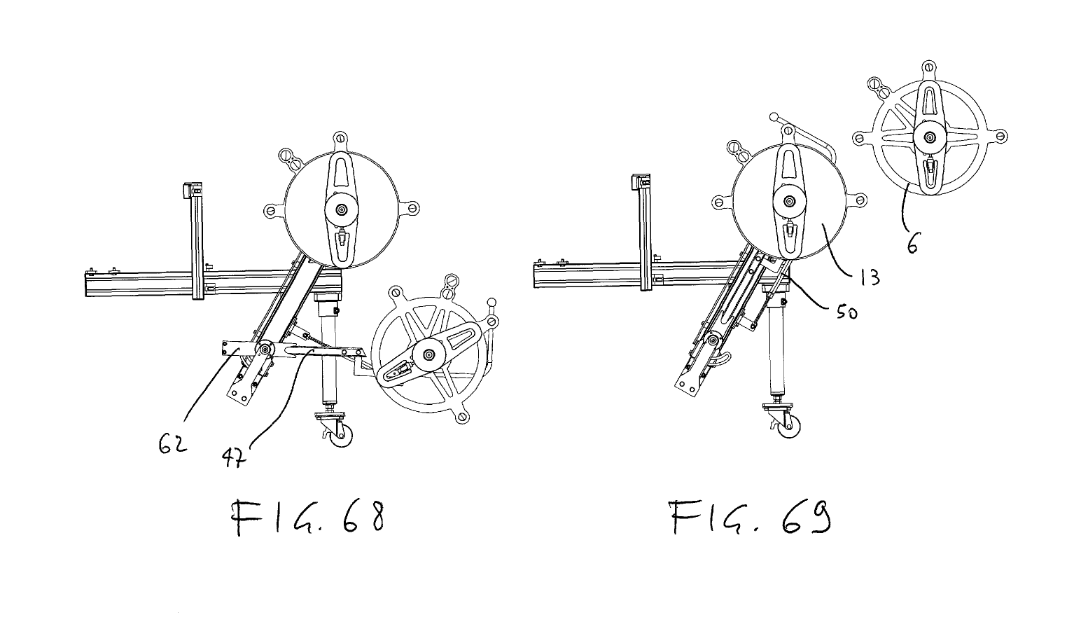

When the body 53 reaches the upper part of the cam portion 56 (FIGS. 62, 63) the interaction between the latter and an upper following roller 57 of the following portion 55 causes a new rotation of the body 53 towards the sustaining position, so that when the body 53 reaches the upper position it is ready to receive and support a new support 6 (FIGS. 64, 65).

In light of what was just described it is now possible to also finish the description of overall operation of the device 1 according to this invention, previously interrupted with reference to the configuration reached in FIG. 40 (and in FIG. 66), that is to say, with the joining completed and the second web 13 having started to unwind from the second reel 14.

At this point, first the first portion 47 of the guide 46 is rotated into the not aligned position (FIG. 67) and the empty support 6 in the first position is removed (FIGS. 41 and 68). When the first portion 47 has been returned to the aligned position (FIG. 69) it is possible to slide the other support 6 from the second position to the first position (FIG. 42).

At that point the other support 6 loaded with a new reel can be fitted on the second portion 48 of the guide 46 until it rests on the body 53 in the sustaining position.

To effectively return to the starting condition at this point the rocker arm 43 simply needs to be returned to the first position. However, in the case of the embodiment illustrated, before rotating the rocker arm 43 into the first position (FIG. 44) it is necessary to extract the detacher 39 (FIG. 45). Once the rocker arm 43 has been returned to the first position the detacher 39 can be repositioned (FIG. 46).

It should be noticed that the latter steps may be carried out either before or after positioning the support 6 with the new reel in the second position. At this point the situation is that illustrated in FIG. 47 with the retaining element 18 ready to receive the starting edge of the new reel, with the related adhesive element on it.

The operation described above of the device 1 illustrated in the accompany drawings is one particular case of implementation of the method according to this invention which will be described below. However, it should be noticed that what was described relative to the device 1 or to the method is also understood to be valid respectively for the method or for the device 1 if compatible.

In general, the method comprises joining two webs with self-adhesive labels, uniting a final end 17 of a first reel 11 of a first web 10 with a starting end 16 of a second reel 14 of a second web 13 (as always, each web comprises a first side 7 bearing the labels and a second side on which there are no labels).

According to this invention, the method comprises the operating steps of: unwinding the first reel 11, making the first web 10 run, at a speed which is less than a maximum speed, along a main feed path along which an operating zone 15 is identified, at least at the operating zone 15 the surface of the first web 10 being positioned parallel to a reference axis; taking the starting end 16 of the second web 13 and applying an adhesive element to the related second side, also making it project as a continuation of the second web 13;

partly unwinding the second reel 14, positioning the second web 13 on a secondary feed path, until the starting end 16, with the adhesive element on it is positioned at the operating zone 15, near to the main feed path at the operating zone 15, and with its first side 7 positioned parallel to the reference axis and facing towards the second side of the first web 10;

near to the end of the transit of the first web 10 through the operating zone 15, detecting the position of a label on the first web 10, and after that detecting operation, making the first web 10 move along the main feed path with a controlled speed, preferably greater than the maximum speed;

while the web is fed with the controlled speed, cutting the first web 10 at a zone of it on which there are no labels, creating the final end 17 of it;

and pressing the final end 17 onto the adhesive element to create the joint, advantageously before making the cut.

Advantageously, before the step of detecting the position of a label on the first web 10 is the step of detecting the end of unwinding of the first reel 11. The step of detecting the position of a label is therefore preferably carried out when the end of unwinding of the first reel 11 has been detected, and, in turn, comprises the steps of creating a sudden inversion in the running path to cause detachment of a front side of a label from the first web 10 and the step of detecting the presence of the detached front side.

Moreover, advantageously, the step of cutting the web is carried out after pressing onto the adhesive element a part of the first web 10 which, after the cutting, will form the final end 17. Moreover, the cutting step preferably comprises positioning a blade 28 along the main feed path to form a cusp in the main feed path, and stopping the first web 10 upstream of the blade 28 (relative to the main feed path) to cause tearing of the first web 10 against the blade 28 after further pulling applied downstream on the first web 10. Advantageously, the method finally comprises, once joining is complete, the step of moving the second reel 14 to the position of the first reel 11 in such a way that the second web 13 runs along the main feed path.

This invention brings important advantages.

In fact, thanks to the device and method according to this invention, it is possible to perform joining in a precise and fully automated way (obviously, that does not mean the step of preparing the starting end of the new reel). Moreover, thanks to this invention there is no longer any need for any storage units for the web downstream of the joining zone, without this resulting in any slowing of machine operation.

Furthermore, in its most complete embodiment, this invention allows joining of webs with self-adhesive labels to be supplied to a labelling machine without being affected by the asymmetrical nature of the webs.

Finally, it should be noticed that even the cost linked to implementing this invention is not very high compared with similar prior art devices. The invention described above may be modified and adapted in several ways without thereby departing from the scope of the inventive concept. Moreover, all details of the invention may be substituted with other technically equivalent elements and the materials used, as well as the shapes and dimensions of the various components, may vary according to requirements.

1. A device for joining webs with self-adhesive labels to be supplied to a labelling machine, comprising:
a supporting structure (5);
at least two supports (6) each for supporting a reel of web with self-adhesive labels fixed on one side of it, the supports (6) being rotatably mounted or mountable on the supporting structure (5), one at a first position and one at a second position;
first guide means (8) defining a main feed path for a first web (10) which in use extends from a first reel (11) mounted on the support (6) positioned in the first position, to an outfeed section (12) where, in use, the web is supplied to the labelling machine, an operating zone (15) being defined along the feed path;
second guide means (9) defining a secondary feed path for a second web (13) which in use extends from a second reel (14) mounted on the support (6) positioned in the second position, to the operating zone (15); and
joining means mounted on the supporting structure (5) at the operating zone (15), for in use joining a starting end (16) of the second web (13) to a final end (17) of the first web (10), by pressing the final end (17) of the first web (10) against an adhesive element fixed to the starting end (16) of the second web (13);
characterised in that the joining means in turn comprise:
a web retaining element (18) mounted at an end portion of the secondary feed path for, in use, selectively retaining the starting end (16) of the second web (13) in the absence of stresses or allowing uncoupling of the starting end (16) of the second web (13) following a pulling action applied on it after at least partial joining of the first web (10) and the second web (13);
a pressure element (26) positioned in said operating zone (15) on the opposite side of the main feed path to the retaining element (18); at least one of either the retaining element (18) or the pressure element (26) being movable relative to the other, between a non-operating position in which they are at a distance from one another and, in use, the first web (10) can freely run between them, and an operating position in which the pressure element (26) is pressed onto the retaining element (18) for, in use, pressing the final end (17) of the first web (10) onto the adhesive element fixed to the starting end (16) of the second web (13) which is retained by the retaining element (18);
at least one cutting element (27), mounted along the main feed path upstream of the pressure element (26), and movable between a non-interference position in which in use it does not interfere with the first web (10) being fed along the main feed path, and a cutting position in which it interferes with main feed path for cutting the first web (10);
movement means for moving the cutting element (27) from the non-interference position to the cutting position; and
means for controlled feeding of the first web (10) along the main feed path, which are operatively associated with the movement means for causing controlled feeding of the first web (10) in the operating zone (15) during the movement of the cutting element (27) towards the cutting position.

2. The device according to claim 1, characterised in that it comprises detecting means mounted along the main feed path for detecting the position of a label on the first web (10), and a control unit operatively connected to the movement means, to the controlled feeding means and to the detecting means for controlling activation of the movement means and the controlled feeding means depending on what is detected by the detecting means.

3. The device according to claim 2, characterised in that the detecting means comprise a label detacher (39) extending transversally to the main feed path and a photocell (40) designed to detect an edge of a label which in use is detached from the web at the detacher (39), at least one of either the detacher (39) or the main feed path being switchable between a passive position or configuration in which the detacher (39) is uncoupled from the main feed path, and an active position or configuration in which the detacher (39) is part of the first guide means (8) and causes a sudden inversion in the main feed path designed to cause the labels to become detached.

4. The device according to claim 3, characterised in that the first guide means (8) also comprise two idle rollers (42) mounted on an oscillating rocker arm (43); the oscillating rocker arm (43) being movable relative to the detacher (39) between a first position corresponding to said passive position or configuration, and a second position corresponding to said active position or configuration, the movement of the rocker arm (43) from the first position to the second position causing adhesion of the web to the detacher (39).

5. The device according to claim 1, characterised in that the controlled feeding means comprise a first roller (34) and a second roller (35), the first roller (34) also being part of the first guide means (8), the first roller (34) and the second roller (35) being movable relative to one another between a distal position in which they are at a distance from each other and the second roller (35) is at a distance from the main feed path, and a proximal position in which they are pressed against one another for, in use, clamping between them the first web (10), and means for causing controlled rotation of the second roller (35) when the first roller (34) and the second roller (35) are in the proximal position.

6. The device according to claim 5, characterised in that the second roller (35) is rotatably connected to a supporting element (37) by means of a freewheel mechanism (38) which allows it to rotate freely relative to the supporting element (37) according to a first direction of rotation compatible with the direction of running of the first web (10) along the main feed path, and prevents it from rotating in a second direction which is opposite to the first, in that the supporting element (37) is in turn rotatable about the same axis of rotation as the second roller (35), and in that the means for causing the controlled rotation of the second roller (35) comprise a first actuator connected to the supporting element (37) to make it rotate according to the first direction of rotation and at a speed which is greater than the maximum speed at which the first web (10) can in use make the second roller (35) rotate.

7. The device according to claim 4, characterised in that the controlled feeding means comprise a first roller (34) and a second roller (35), the first roller (34) also being part of the first guide means (8), the first roller (34) and the second roller (35) being movable relative to one another between a distal position in which they are at a distance from each other and the second roller (35) is at a distance from the main feed path, and a proximal position in which they are pressed against one another for, in use, clamping between them the first web (10), and means for causing controlled rotation of the second roller (35) when the first roller (34) and the second roller (35) are in the proximal position, and in that the first roller (34) is one of the two idle rollers (42) mounted on the rocker arm (43).

8. The device according to claim 1, characterised in that the pressure element (26) is fixed to the cutting element (27), in that both are together rotatably connected to the supporting structure (5), the non-operating position of the pressure element (26) corresponding to the non-interference position of the cutting element (27), when the cutting element (27) is in the cutting position the pressure element (26) being in the operating position.

9. The device according to claim 1, characterised in that the cutting element (27) comprises a blade (28) and a stop element (29) which are transversal to the main feed path, in the cutting position the stop element (29) being in contact against a contact element (30) for retaining between itself and the contact element (30) the first web (10), pulling of the first web (10) along the main feed path causing it to tear against the blade (28).

10. The device according to claim 3, characterised in that the cutting element (27) comprises a blade (28) and a stop element (29) which are transversal to the main feed path, in the cutting position the stop element (29) being in contact against a contact element (30) for retaining between itself and the contact element (30) the first web (10), pulling of the first web (10) along the main feed path causing it to tear against the blade (28), and in that the contact element (30) is constituted of the detacher (39).

11. The device according to claim 1, characterised in that the retaining element (18) comprises a follower (24) slidably coupled to a cam element (25) movably mounted on the supporting structure (5), for causing the movement of the retaining element (18) between the non-operating position and a safe position in which it is further from the main feed path than when it is in the non-operating position.

12. The device according to claim 4, characterised in that the retaining element (18) comprises a follower (24) slidably coupled to a cam element (25) movably mounted on the supporting structure (5), for causing the movement of the retaining element (18) between the non-operating position and a safe position in which it is further from the main feed path than when it is in the non-operating position, and in that the cam element (25) is fixed to the rocker arm (43) and in that when the rocker arm (43) is in its first position the cam element (25) keeps the retaining element (18) in the safe position, and when the rocker (43) is in the second position, the cam element (25) allows positioning of the retaining element (18) in the non-operating position.

13. The device according to claim 1, characterised in that the positions of the two supports (6) can be inverted, and in that a support (6) positioned in the second position can be moved to the first position, allowing, during the entire movement, unwinding of the second web (13) from the second reel (14) and its free feeding from the second reel (14) towards the operating zone (15).

14. The device according to claim 3, characterised in that the positions of the two supports (6) can be inverted, and in that a support (6) positioned in the second position can be moved to the first position, allowing, during the entire movement, unwinding of the second web (13) from the second reel (14) and its free feeding from the second reel (14) towards the operating zone (15), and in that said detacher (39) is also movable transversally to the main feed path between an inserted position in which it is opposite the main feed path, and an extracted position in which it is not opposite the main fed path and allows the passage of a web from the secondary feed path to the main feed path during the passage of the related support (6) from the second position to the first position.

15. The device according to claim 13, characterised in that the supporting structure (5) also comprises a guide (46) on which the supports (6) are slidably mounted, each support (6) being able to pass from the second position to the first position by sliding along the guide (46).

16. The device according to claim 15, characterised in that said guide (46) comprises two separate portions, a first portion (47) defining the first position for the supports (6) and a second portion (48) defining the second position for the supports (6), in that at least the first portion (47) is rotatable between an aligned position in which it is aligned with the second portion (48) and allows the passage of a support (6) from the second portion (48) to the first portion (47), and a rotated position in which it is not aligned with the first portion (47) and allows the removal of a support (6) from it, and in that the second portion (48) in turn, on the opposite side to the first portion (47), is open to allow one of the supports (6) to be coupled to it.

17. The device according to claim 15, characterised in that the guide (46) comprises at least one vertical component of extension and in that it also comprises at least one positioning unit (52), movable parallel to the guide (46) between an upper position in which it retains a support (6) positioned in the second position, a lower operating position in which it supports a support (6) positioned substantially in the first position, and a lower non-operating position in which it is positioned lower than the lower operating position and is uncoupled from the support (6) in the first position.

18. The device according to claim 17, characterised in that the positioning unit (52) also comprises a body (53) comprising a resting portion (54) for a support (6) and a following portion (55) slidably associated with a cam portion (56) of the supporting structure (5), said body (53) being rotatable, about an axis of rotation transversal to a main line of extension of the guide (46), between a sustaining position in which the resting portion (54) can interact with a support (6) mounted on the guide (46) so as to sustain it, and a home position in which the resting portion (54) cannot engage with a support (6) associated with the guide (46), elastic means (58) being associated with the body (53) for pushing it towards the home position; the cam portion (56) causing the positioning of the body (53) in the sustaining position at least at the upper position of the positioning unit (52), and allowing it to rotate towards the home position at least near to and at the lower operating position and between the lower operating position and the lower non-operating position, for allowing translation of the positioning unit (52) from the non-operating home position to the sustaining position even when a support (6) is present in the respective first position.

19. The device according to claim 13, characterised in that the supporting structure (5) also comprises a frame rotatable about an axis which in use is parallel to an axis of rotation of the reels mounted on the supports (6), and in that the supports (6) are mounted on said frame on opposite sides of the axis of rotation of the frame, the movement of one support (6) from the first position to the second position and of the other support (6) from the second position to the first position being achievable by rotating the frame.

20. A labelling machine comprising a device (1) according to claim 1.

21. A method for joining two webs with self-adhesive labels, joining a final end (17) of a first reel (11) of a first web (10) to a starting end (16) of a second reel (14) of a second web (13), each web comprising a first side (7) bearing the labels and a second side on which there are no labels, the method comprising the operating steps of:
unwinding the first reel (11), making the first web (10) run, at a speed which is less than a maximum speed, along a main feed path along which an operating zone (15) is identified, at least at the operating zone (15) the surface of the first web (10) being positioned parallel to a reference axis;
taking the starting end (16) of the second web (13) and applying an adhesive element to the related second side, also making it project as a continuation of the second web (13);
partly unwinding the second reel (14), positioning the second web (13) on a secondary feed path, until the starting end (16) with the adhesive element on it is positioned near to the main feed path at the operating zone (15), and with its first side (7) positioned parallel to the reference axis and facing towards the second side of the first web (10);
near to the end of the transit of the first web (10) through the operating zone (15) detecting the position of a label on the first web (10), and after that detecting operation, making the first web (10) move along the main feed path with a controlled speed;
while the web is fed with said controlled speed, cutting the first web (10) at a zone of it on which there are no labels, creating the final end (17) of it;
and pressing the final end (17) onto the adhesive element to create the joint.

22. The method according to claim 21, wherein the controlled speed is greater than the maximum speed.

23. The method according to claim 21, wherein before the step of detecting the position of a label on the first web (10) there is the step of detecting the end of unwinding of the first reel (11), and wherein the step of detecting the position of a label is carried out once the end of unwinding of the first reel (11) has been detected and comprises the steps of creating a sudden inversion in the running path to cause detachment of a front side of a label from the first web (10) and the step of detecting the presence of said detached front side.

24. The method according to claim 21, wherein the step of cutting the web is carried out after pressing onto the adhesive element a part of the first web (10) which, after the cutting, will form the final end (17).

25. The method according to claim 21, wherein the cutting step comprises positioning a blade (28) along the main feed path to form a cusp in the main feed path, and stopping the first web (10) upstream of the blade (28), relative to the main feed path, for causing tearing of the first web (10) against the blade (28).

26. The method according to claim 21, finally comprising, once joining is complete, the step of moving the second reel (14) to the position of the first reel (11) in such a way that the second web (13) runs along the main feed path.
